(19) United States
(12) Patent Application Publication
(10) Pub. No.: US 2001/0049624 A1
(43) Pub. Date: Dec. 6, 2001

(54) Advertisement distributing method and system

(76) Inventors: Masashi Uyama, Kawasaki (JP); Noboru Iwayama, Kawasaki (JP); Youji Kohda, Kawasaki (JP); Yuji Kijima, Kawasaki (JP)

Correspondence Address: STAAS & HALSEY LLP, 700 11TH STREET, NW, SUITE 500, WASHINGTON, DC, 20001, US

(21) Appl. No.: 09/737,846

(22) Filed: Dec. 18, 2000

(30) Foreign Application Priority Data
Jun. 6, 2000 (JP) 2000-169316

(51) Int. Cl. G06F 17/60

(52) U.S. Cl. 705/14

(57) ABSTRACT

A prospective customer searching part searches a customer database on the Internet based on information regarding a target article, a shop searching part searches a shop database, and a prospective customer list generating part generates a prospective customer list for each shop. A prospective customer list presenting part presents the list, and a shop determines whether or not advertisement is to be distributed to each prospective customer by using an advertisement distribution selecting part. An advertisement distribution preliminary list generating part excludes customers selected not to receive advertisement to generate an advertisement distribution preliminary list. A name-embedded advertisement generating part generates advertisement using advertisement data in accordance with the advertisement distribution preliminary list, and a name-embedded advertisement distributing part distributes the name-embedded advertisement to customers.

### BACKGROUND OF THE INVENTION

1. Field of the Invention

The present invention relates to an advertisement distributing system for a small/medium-size shop to find prospective customers from customer data managed by an Internet provider so as to develop new customers, and to distribute advertisement of an advertising article among the prospective customers and the existing regular customers of the shop, while considering a relationship therebetween.

2. Description of the Related Art

Conventionally, as a method for issuing advertisement to target customers, a frequent shopper program is known, which uses customer identification information such as a member card. This program has been used by many shops. According to the frequent shopper program, for example, a customer is identified based on a member card represented by the customer at the time of purchase of an article, and article purchase information is collected for management on a customer basis. The program allows purchase behavior to be traced on a customer basis. Furthermore, if customer information is obtained when a customer signs up for the frequent shopper program under the condition of the customer's acceptance, it becomes possible to expect, to some degree, when a customer having what kind of attributes will buy what kind of article, based on the analysis of the purchase behavior obtained from the information on preferences of the customer contained in the customer information and the customer's purchase history. This allows advertisement such as direct mail to be issued to target customers.

The object of the above-mentioned conventional frequent shopper program is not to develop new customers, but to enlarge a share in which a regular customer purchases articles in a shop in a lifetime. Therefore, the frequent shopper program is suitable for large-size shops that have already gained a number of frequent customers. Even if a small/medium size shop, which is losing customers to large-size shops, manages a frequent customer database, there may not be great benefit from using it for the following reasons. In order to expect who will purchase what kind of article at which time, a data mining tool for analyzing the purchase history of customers is required. However, when the absolute number of customers is small, an effect commensurate with investment cannot be expected. Furthermore, even if it can be expected who will purchase what kind of article at which time, a small/medium-size shop is required to create its own advertisement for providing customers with article information. In this case, since the number of issues of advertisement is small, a cost for creating advertisement becomes comparatively high; consequently, an effect commensurate with investment cannot be expected.

As described above, according to the conventional frequent shopper program, although purchase history information is accumulated in a database on a customer basis, information only on regular customers is managed, so that such purchase history information cannot be used for developing new customers.

Thus, it is generally required for small/medium-size shops having fewer customers to develop new customers or to regain customers lost to large-size shops, while keeping regular customers. However, a high cost is incurred for small/medium-size shops to develop new customers, while maintaining service to regular customers.

As an effective method for developing customers, there is a method for distributing advertisement of articles to customers. Advertisement is an effective method for various kinds of manufacturers producing articles targeted at general consumers to announce their own new products, to allow their own brand images to penetrate in the public, and to emphasize the superiority of their own products over the other products. The past investment in advertisement leads to an increase in a sales cost; therefore, it is desirable to specify potential customers of products and to distribute advertisement to the target customers.

JP 9(1997)-91358 A entitled “Information Providing Apparatus and Method” discloses an advertisement distributing system capable of accurately narrowing a target for distributing advertisement. According to this system, in order to effectively narrow a target for distributing various kinds of information sent by a sender, a receiver registers advertisement receiving requirements and a sender registers advertisement distribution requirements so that both the requirements can be checked against each other. In this system, a user is required to previously accept that a user's individual profile should be submitted, and that a user will receive advertisement based on the profile. In general, when a user has to bear a predetermined burden so as to receive service, a user's previous acceptance is required. Herein, a service providing style predicated on a user's previous acceptance is referred to as an “Opt-in”, and an advertisement distributing system for selectively distributing advertisement in accordance with individual users based on the individual profiles under the condition of user's acceptance is referred to as an “Opt-in advertisement distributing system”.

A conventional advertising medium (newspaper, magazine, TV, etc.) only provides an ambiguous presentation of a shop such as “Visit a shop of XXX company in the neighborhood”, in order to distribute the same advertisement in a wide region. In contrast, according to the Opt-in advertisement distributing system as in JP 9(1997)-91358 A, a shop in the neighborhood is specified based on the address information regarding an individual who is to receive advertisement, and the name of the shop can be inserted in the advertisement. For example, a sentence “Visit a XXX shop, located at the Honmachi intersection” can be inserted. More specifically, if there is a database managing “articles, shops dealing with the articles, and addresses of the shops” in addition to the system disclosed by JP 9(1997)-91358 A, shop information regarding “which shop a user should visit to obtain the article” can be added to advertisement, which enhances convenience of users who have received the advertisement.

Thus, “name-embedding” for inserting information regarding shops selling the article in advertisement is required. Advertisement in which the name-embedding is conducted is referred to as “name-embedded advertisement”. Because of the name-embedded advertisement, a receiver thereof can specify a place for obtaining an advertising article and easily purchase it. This leads to an increase in sales of articles for manufacturers. Furthermore, shops can attract customers without incurring too much cost of advertisement.

FIG. 28 is a block diagram showing a structure of an Opt-in name-embedded advertisement distributing system that can be assumed in the prior art. An article advertisement database 701 stores article advertisement data provided by a manufacturer. The article advertisement data contains advertisement distribution requirements defining to what kind of individuals manufacturers desire to distribute advertisement, as well as advertisement IDs, article IDs, article names, article types, and advertisement data.

A customer database 702 stores individual profiles of customers who desire to receive advertisement. Each individual profile contains advertisement receiving requirements defining what kind of advertisement customers desire to receive, as well as customer IDs, customer names, and electronic mail addresses of customers.

A shop selecting part 705 extracts shops that deal in an advertising article from a shop database 704, searches the customer database 702 for addresses of customers who are to receive advertisement, and selects shops located close to the addresses. The shop database 704 holds shop IDs, shop names, addresses of shops, TEL numbers of shops, and article types dealt in by shops.

A distribution list creating part 703 refers to the advertisement receiving requirements and the advertisement distribution requirements, extracts pairs of advertisement and customers satisfying both the requirements, and creates an distribution list that is a group collection of “an advertisement ID, a customer ID, an article ID, and a shop ID”.

An advertisement information distributing part 706 embeds shop information corresponding to a shop ID in advertisement data corresponding to an advertisement ID for each element in the distribution list to modify advertisement data, and distributes the advertisement data to electronic mail addresses of customers corresponding to customer IDs. A name-embedding part 707 searches the article advertisement database 701 for advertisement data with respect to each advertisement, searches the shop database 704 for shop names, shop addresses, and TEL numbers of shops identified by the shop IDs, and creates name-embedded advertisement data in which names, addresses, and TEL numbers are embedded. An advertisement information distributing part 706 distributes the name-embedded advertisement data to target customers through electronic mail.

According to the conventional Opt-in name-embedded advertisement distributing system, a third party independent of shops and manufacturers can collect and manage individual profiles. For example, it is considered that an Internet service provider, a credit card company, and the like collect and mange individual profiles under the condition of user's acceptance. According to the frequent shopper program, a database of regular customers is used as a customer database. However, the Opt-in advertisement distributing system uses a large-scale customer database that is not limited to customers of particular shops, which can be utilized for developing new customers. More specifically, as the number of users registered in the customer database is larger and the detail of individual profiles is richer, the advantage of using the customer database for gaining new customers is higher.

If shops use the advertisement distributing system to issue name-embedded advertisement to a number of prospective customers, development of new customers will be expected.

However, according to the Opt-in name-embedded advertisement distributing system assumed in the prior art, an appropriate relationship cannot be maintained between the prospective customers (new customers) and the existing regular customers, and a problem of losing trust of the regular customers may arise. For example, in the case where a small/medium-size shop uses the Opt-in name-embedded advertisement system for developing new customers, the customers obtained from the customer database of the Opt-in name-embedded advertisement system are provided with service such as distribution of advertisement, whereas the existing regular customers cannot be provided any service. This problem can be overcome by providing information on the existing regular customers to the Opt-in name-embedded advertisement distributing system by a shop, and equally distributing the identical advertisement to the prospective customers and the existing regular customers. However, shops are unlikely to provide information on their own regular customers (which is an asset and trade secret of the shops) as a part of a large-scale customer database. Thus, this is not a realistic solution to the problem. Furthermore, the large-scale shop database of the Opt-in name-embedded advertisement distributing system and the information on regular customers owned by shops are different in data contents and attributes, and also in a use range of customer information and acceptance conditions of customers with respect to the use of the method. Therefore, it is not possible to merely provide the information on regular customers owned by shops to the large-scale customer database of the Opt-in name-embedded advertisement distributing system.

Furthermore, in the case where a part of customers registered in the large-scale customer database of the Opt-in name-embedded advertisement distributing system overlaps the regular customers, the following problem arises. If the identical advertisement is distributed equally to the prospective customers and the existing regular customers, the regular customers may receive inappropriate direct mail from a shop with which the regular customers deal a lot and which is supposed to know the customers' purchase history well. For example, in spite of the fact that a regular customer purchased an article in a shop, the customer receives direct mail recommending the customer to buy the same article from the shop, which impairs the impression of the customer with respect to the shop.

### SUMMARY OF THE INVENTION

Therefore, with the foregoing in mind, it is an object of the present invention to provide an advertisement distributing system and method enabling a shop to minutely adjust a target for distributing advertisement, using a large-scale external customer database, which is different from a customer database owned by a shop, for finding prospective customers.

Another object of the present invention is to provide an advertisement distributing system and method enabling a shop to minutely adjust a target for distributing advertisement without giving or disclosing customer information on regular customers (which is an asset to the shop) owned by the shop to third parties.

Still another object of the present invention is to provide an advertisement distributing system and method allowing a shop to generate name-embedded advertisement of an article at a low cost.

In order to solve the above-mentioned problems, the method for distributing advertisement of the present invention includes: a prospective customer searching operation of searching for prospective customers of an advertising article from customer information; a shop searching operation of searching for shops that are capable of selling the article to the prospective customers from shop information; a prospective customer notifying operation of creating a prospective customer list of the prospective customers, to which the shops are capable of selling the article, on a shop basis, and notifying the shops of the list; an advertisement distribution selecting operation of allowing the shops to determine whether or not advertisement regarding the article is to be distributed to the prospective customers in the notified prospective customer list; a name-embedded advertisement generating operation of generating name-embedded advertisement in which shop identity information capable of identifying the shops is added to the advertisement previously registered; and a name-embedded advertisement distributing operation of distributing the name-embedded advertisement to the prospective customers selected to receive the name-embedded advertisement in the advertisement distribution selecting operation.

According to the above-mentioned structure, a shop can minutely adjust a target for distributing advertisement while using a large-scale customer database for the purpose of finding prospective customers. Furthermore, the shop can minutely adjust a target for distributing advertisement without giving or disclosing customer information on regular customers owned by the shop to third parties.

Furthermore, the method for distributing advertisement of the present invention includes: an advertisement target article specifying operation of specifying an article which a shop desires to advertise; a prospective customer searching operation of searching for prospective customers of the article from customer information; an advertisement distribution selecting operation of allowing the shop to determine whether or not advertisement regarding the article is to be distributed to the prospective customers in the searched prospective customer list; a name-embedded advertisement generating operation of generating name-embedded advertisement in which shop identity information capable of identifying the shop is added to the advertisement previously registered; and a name-embedded advertisement distributing operation of distributing the name-embedded advertisement to the prospective customers selected to receive the advertisement in the advertisement distribution selecting operation.

According to the above-mentioned structure, based on the initiative of the shop side, the shop side can select an article which the shop side desires to advertise, and minutely adjust a target for distributing advertisement while using a large-scale customer database for the purpose of finding prospective customers.

Furthermore, the method for distributing advertisement of the present invention includes: an advertising article specifying operation in a shop; a regular customer selecting operation of allowing the shop to determine whether or not advertisement regarding the article is to be distributed to each regular customer, based on regular customer information; a prospective customer searching operation of searching for prospective customers to which the shop is capable of selling the article, and creating a prospective customer list; a regular customer addition operation of generating an advertisement distribution preliminary list by excluding the customers, who have selected not to receive the advertisement in the regular customer selecting operation, from the prospective customer list, and by adding the regular customers selected to receive the advertisement in the regular customer selecting operation; a name-embedded advertisement generating operation of generating name-embedded advertisement in which shop identity information capable of identifying the shop is added to the advertisement; and name-embedded advertisement distributing operation of distributing the name-embedded advertisement to customers in the advertisement distribution preliminary list.

According to the above-mentioned structure, based on the initiative of the shop side, the shop side can specify customers to which the shop side desires to distribute advertisement among regular customers managed by the shop side, and adjust the contents of a list of prospective customers uniformly selected from a large-scale database based on the specification.

Next, the advertisement distributing method of the present invention can perform billing in accordance with the number of advertisements. The advertisement distributing method of the present invention includes an advertisement distribution billing operation including: an advertisement unit price setting operation of setting an advertisement unit price for billing an advertisement provider per advertisement with respect to the advertisement of the article; a prospective customer distribution fee unit price setting operation of setting a unit price of a prospective customer distribution fee provided to a shop per distribution to prospective customers; a regular customer distribution fee unit price setting operation of setting a unit price of a regular customer distribution fee provided to a shop per distribution to regular customers; an advertisement fee calculating operation of calculating an advertisement fee by multiplying the advertisement unit price by the number of name-embedded advertisements distributed in the name-embedded advertisement distributing operation; an advertisement fee charging operation of charging the advertisement fee to the advertisement provider; and an advertisement distribution shop fee providing operation of providing an advertisement distribution shop fee calculated by adding a product obtained by multiplying the prospective customer distribution fee unit price by the number of name-embedded advertisements distributed to the prospective customers, to a product obtained by multiplying the regular customer distribution fee unit price by the number of name-embedded advertisements distributed to the regular customers.

According to the above-mentioned structure, a specific advertisement fee is provided to an advertisement provider, in accordance with the number of distributed advertisements, and a specific advertisement fee is provided to a shop, in accordance with the number of distributed name-embedded advertisements. An advertisement distributing system administrator can obtain the difference between the former and latter fees. The advertisement distributing system of the present invention can be considered to bring merits to the advertisement provider, the shop, and the system administrator.

The advertisement distributing method of the present invention can perform billing in accordance with sales performance. The advertisement distributing method of the present invention includes a sales billing operation including: a sales fee unit price setting operation of setting a sales fee unit price for billing the advertisement provider per sales performance; a sales performance obtaining operation of obtaining a sales volume of the article sold to customers who have received the advertisement; a prospective customer sales fee unit price setting operation of setting a unit price of a prospective customer sales fee provided to a customer sales performance with respect to the prospective customers; a regular customer sales fee unit price setting operation of setting a unit price of a regular customer sales fee provided to the customer sales to the regular customers; a sales fee calculating operation of calculating a sales fee by multiplying the sales fee unit price by the sales volume obtained in the sales performance obtaining operation; and a shop sales fee providing operation of providing an advertisement distribution shop fee calculated by adding a product obtained by multiplying the prospect customer sales fee unit price by the sales volume with respect to the prospective customers, to a product obtained by multiplying the regular customer sales fee unit price by the sales volume with respect to the regular customers.

According to the above-mentioned structure, a specific advertisement fee is provided to an advertisement provider, in accordance with the sales volume obtained by distribution of advertisement, and a specific advertisement fee is provided to a shop, in accordance with the sales volume obtained by distribution of advertisement. An advertisement distributing system administrator can obtain the difference between the former and latter fees. The advertisement distributing system of the present invention can be considered to bring merits to the advertisement provider, the shop, and the system administrator.

The advertisement distributing system can be constructed as a client-server system. The advertisement distributing server includes: a prospective customer searching part for searching for prospective customers of an advertising article from an accessible customer database; a shop database storing shop information; a shop searching part for searching for shops capable of selling the article to the prospective customers from the shop database; a prospective customer list generating part for generating a prospective customer list of prospective customers for each shop; a prospective customer list sending part for sending the prospective customer list for each shop to the shop; a name-embedded advertisement generating part for receiving a result of the shop's determination whether or not the advertisement is to be distributed to the prospective customers in the prospective customer list, and generating name-embedded advertisement including shop identity information capable of identifying the shop, based on the result; a name-embedded advertisement distributing part for distributing the name-embedded advertisement to the prospective customers who have selected to receive the name-embedded advertisement by the advertisement distribution selecting part. The advertisement distributing client includes: a prospective customer notifying part for receiving a prospective customer list that is a search result of prospective customers of an advertising article from a customer database accessible from an advertisement distribution server, and presenting the list to a shop side; an advertisement distribution selecting part for determining whether or not advertisement of the article is to be distributed to the prospective customers in the prospective customer list; and an advertisement distribution selection result notifying part for returning a selection result of the advertisement distribution selecting part to the advertisement distributing server, the advertisement distributing client requesting the advertisement distributing server to distribute the advertisement to customers who are specified to receive the advertisement. Thus, the advertisement distribution system of the present invention can be constructed as a client-server system.

Furthermore, the advertisement distributing system of the present invention can be constructed, using a computer, by reading a processing program from a computer-readable recording medium storing the processing program for realizing the above-mentioned advertisement distributing system.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing an exemplary structure of an advertisement distributing system in Embodiment 1 according to the present invention.

FIG. 2 shows a data example stored in an advertisement distribution information database.

FIG. 3 shows a data example stored in a customer database.

FIG. 4 shows a data example held and registered in a shop database.

FIG. 5 shows a data example generated by a prospective customer list generating part.

FIG. 6 shows an advertisement data example stored in an advertisement data storing part.

FIG. 7 shows a state where a “prospective” flag in a prospective customer list presented through a prospective customer list presenting part is overwritten.

FIG. 8 shows an example of an advertisement distribution preliminary list.

FIG. 9 is a flow chart showing processing of an advertisement distributing system and method according to the present invention.

FIG. 10 is a flow chart showing a procedure of creating a prospective customer list in Embodiment 1 according to the present invention.

FIG. 11 is a flow chart showing a procedure of creating an advertisement distribution preliminary list.

FIG. 12 is a flow chart showing a procedure of creating advertisement.

FIG. 13 is a block diagram showing an exemplary structure of a shop system in Embodiment 2 according to the present invention.

FIG. 14 is flow chart showing processing of selecting an advertising article in Embodiment 2 according to the present invention.

FIG. 15 is a block diagram showing an exemplary structure of an advertisement distributing system in Embodiment 3 according to the present invention.

FIG. 16 is a flow chart showing processing of an advertisement distributing system in Embodiment 3 according to the present invention.

FIG. 17 is a flow chart showing a procedure of creating an advertisement distribution preliminary list in more detail.

FIG. 18 shows a data example in a regular customer database independently managed by a shop in a frequent shopper program on a shop side.

FIG. 19 shows a state where a customer is added through an additional customer specifying part of an advertisement distribution customer adding part.

FIG. 20 shows a state where the results of selection of advertisement distribution and the results of specifying of advertisement distribution addition are merged with each other to create an advertisement distribution preliminary list.

FIG. 21 shows an example in which an advertisement distributing system supplies data that is lacking in an advertisement distribution preliminary list.

FIG. 22 is a block diagram showing an exemplary structure of a shop system in Embodiment 4 according to the present invention.

FIG. 23 is a flow chart showing processing of an advertisement distributing system in Embodiment 4 according to the present invention.

FIG. 24 is a flow chart showing a procedure of creating a prospective customer list in more detail.

FIG. 25 is a flow chart showing a procedure of creating an advertisement distribution preliminary list in more detail.

FIG. 26 is a block diagram showing an exemplary structure of an advertisement distributing system in Embodiment 5 according to the present invention.

FIG. 27 shows exemplary recording media storing a processing program that realizes an advertisement distributing system in Embodiment 6 according to the present invention.

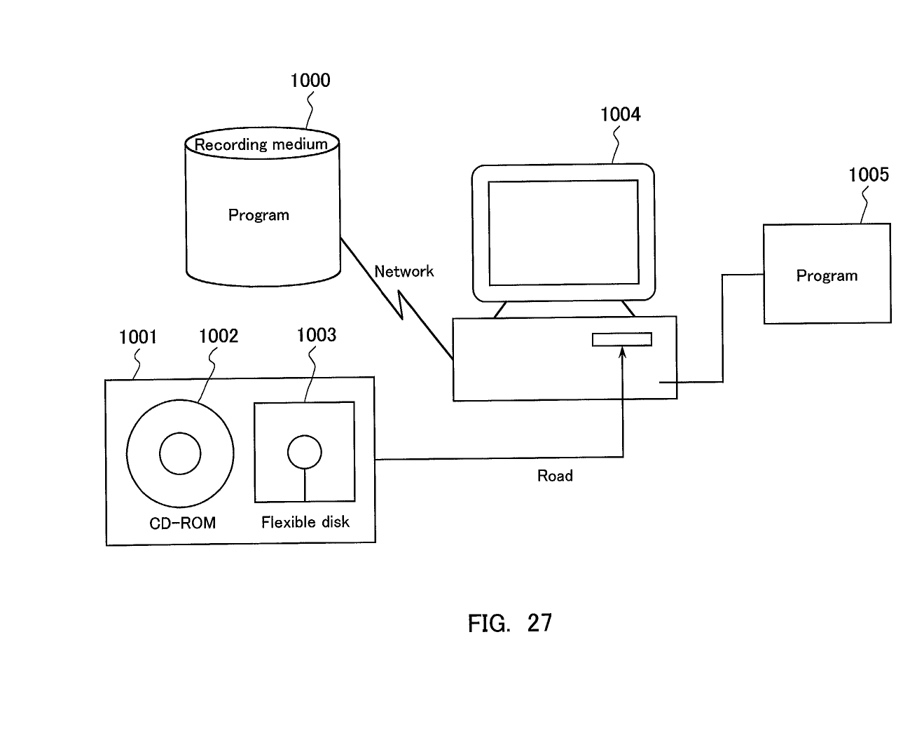

FIG. 28 is a block diagram showing a structure of an Opt-in name-embedded advertisement distributing system that can be assumed in the prior art.

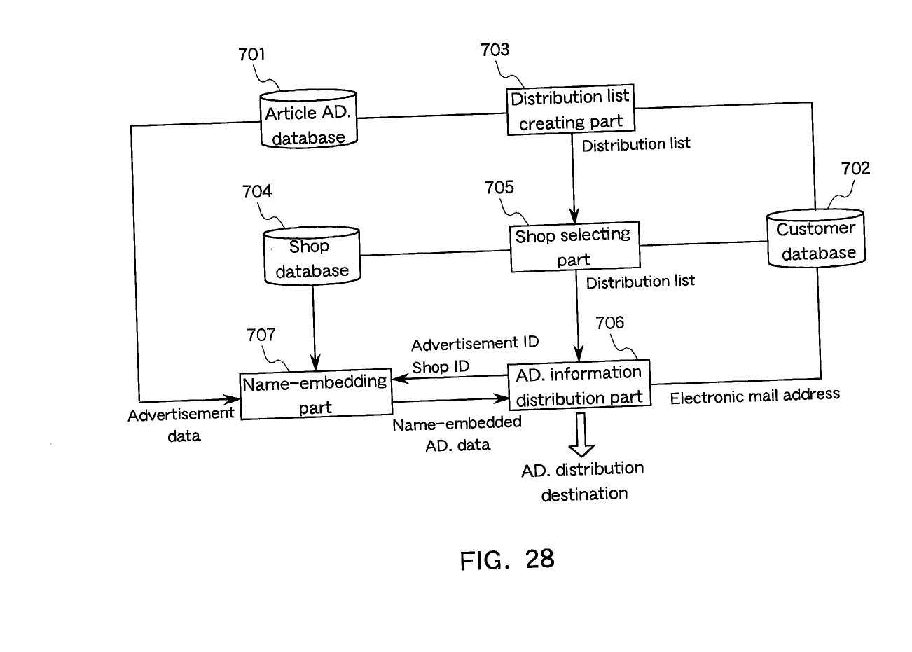

### DESCRIPTION OF THE PREFERRED EMBODIMENTS

The advertisement distributing system and method according to the present invention will be described by way of illustrative embodiments.

Embodiment 1

The advertisement distributing system and method in Embodiment 1 will be described with reference to the drawings. In Embodiment 1, the case will be described where prospective customers are extracted from a large-scale customer database storing customer information managed by an Internet provider, whether or not advertisement is distributed is minutely adjusted on a prospective customer basis, and electronic mail or banner advertisement is distributed to customers on the Internet.

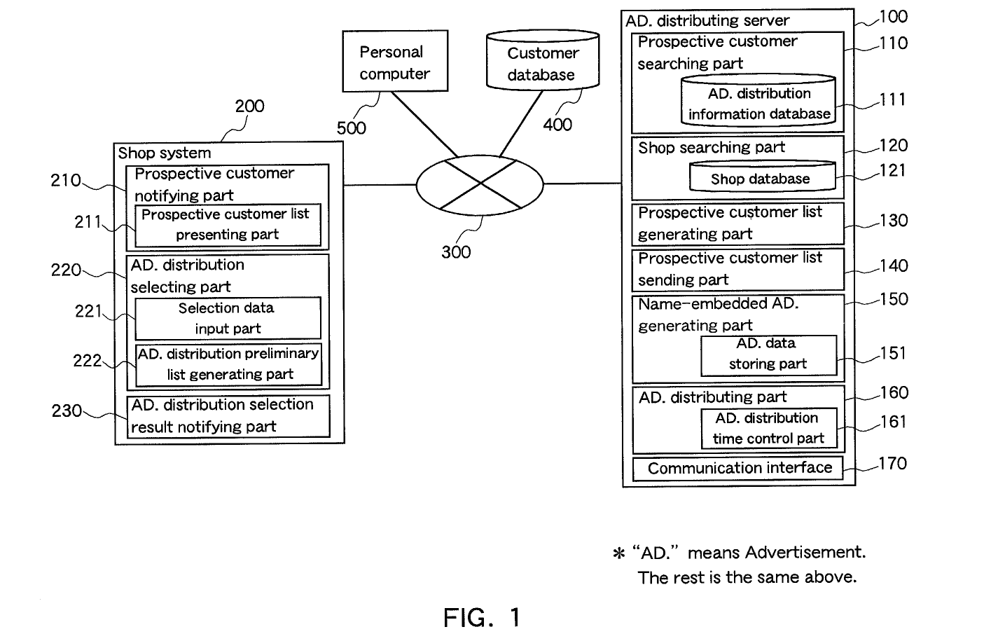

FIG. 1 schematically shows a mechanism of the advertisement distributing system in Embodiment 1. The advertisement distributing system in Embodiment 1 includes an advertisement distributing server 100 and a shop system 200 that is an advertisement distributing client placed in each shop. The advertisement distributing server 100 is connected to the shop system 200 through the Internet or a network 300 such as a private line. Reference numeral 400 denotes a customer database accessible by the advertisement distributing server 100. In Embodiment 1, it is assumed that the customer database is a large-scale database storing customer information managed by an Internet provider. Reference numeral 500 denotes a personal computer owned by each prospective customer, which receives advertisement from the advertisement distributing server 100 through the network 300, and displays the advertisement on a monitor.

Hereinafter, the advertisement distributing server 100 and the shop system 200 will be specifically described. First, the advertisement distributing server 100 will be described.

Reference numeral 110 denotes a prospective customer searching part, 120 denotes a shop searching part, 121 denotes a shop database, 130 denotes a prospective customer list generating part, 140 denotes a prospective customer list sending part, 150 denotes a name-embedded advertisement generating part, 160 denotes an advertisement distributing part, and 170 denotes a communication interface. Furthermore, in Embodiment 1, the name-embedded advertisement generating part 150 optionally includes an advertisement data storing part 151, and the advertisement distributing part 160 optionally includes an advertisement distribution time control part 161.

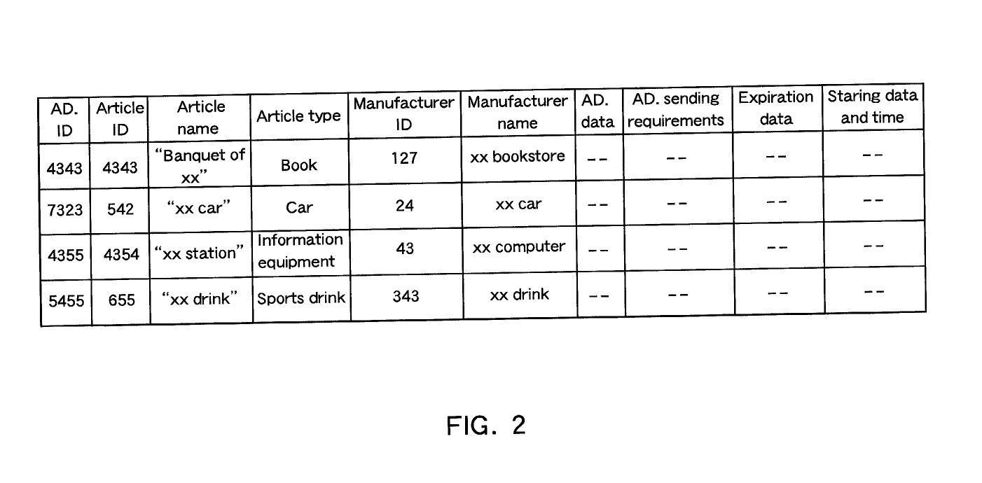

The prospective customer searching part 110 is used for searching the accessible customer database 400 for prospective customers of an advertising article. In searching for prospective customers, the prospective customer searching part 110 uses attribute information on customers as search conditions. In the case where there are advertisement receiving requirements regarding acceptance/rejection of advertisement on a customer basis, the prospective customer searching part 110 also uses the advertisement receiving requirements as search conditions. In Embodiment 1, the prospective customer searching part 110 optionally includes an advertisement distribution information database 111. The advertisement distribution information database 111 holds and stores article attribute information. FIG. 2 shows a data example stored in the advertisement distribution information database 111. In this example, each data contains an advertisement ID, an article ID, an article name, an article type, a manufacture ID, a manufacture name, advertisement data, advertisement distribution requirements, an expiration date, and a starting time. Among them, the advertisement data refers to actual advertising message data composed of character string data, image data, and voice data. The advertisement data can be used as a kind of template for embedding information on a target for distributing advertisement and information on each shop that is an advertisement owner to easily create name-embedded advertisement. The advertisement data may be prepared for each advertising article, or may include a layout or a fixed format regarding advertisement for general use. In this case, the advertisement data can be filled with a name of an article to be an advertising article or information on selling points of the article and the like.

The advertisement data may also contain an incentive such as a discount coupon. Since a plurality of kinds of advertisement data can be prepared for the identical article, each data in the advertisement distribution information database 111 contains an advertisement ID as well as an article ID.

Herein, the starting time information refers to information indicating a starting time of distribution of advertisement that is an advertisement distribution starting requirement given to each article advertisement. As described later, an advertisement distribution selecting part 220 allows a shop to select prospective customers until the starting time, and thereafter, processing is started and carried out in the name-embedded advertisement generating part 150 and the advertisement distributing part 160. Alternatively, when the name-embedded advertisement generating part 150 and the advertisement distributing part 160 are informed of that the selection of prospective customers by a shop is completed, name-embedded advertisement of the shop may be distributed.

The above-mentioned advertisement distribution information can be appropriately updated by manufacturers, major sales dealers, and the like. Examples of the update include update of information on existing articles, and addition of information on new articles to be developed and sold.

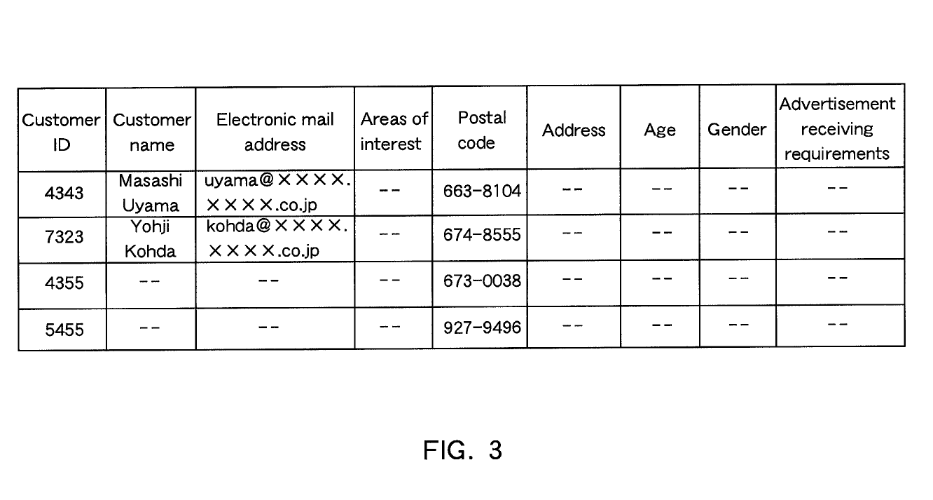

The customer database 400 accessible by the prospective customer searching part 110 stores information on customers who desire to receive advertisement, and individual profile information. The customer information and the individual profile information contain advertisement distribution requirements defining what kind of advertisement customers desire to receive. More specifically, in registering customer information, some customers specify rejection of all the direct mail, direct mail of particular fields, or direct mail from particular shops; the information regarding the receiving of advertisement is also contained in the customer information and the individual profile information. FIG. 3 shows a data example stored in the customer database 400. In this example, each data contains a customer ID, a customer name, an electronic mail address, a hobby, a postal code, an address, an age, a gender, and advertisement receiving requirements.

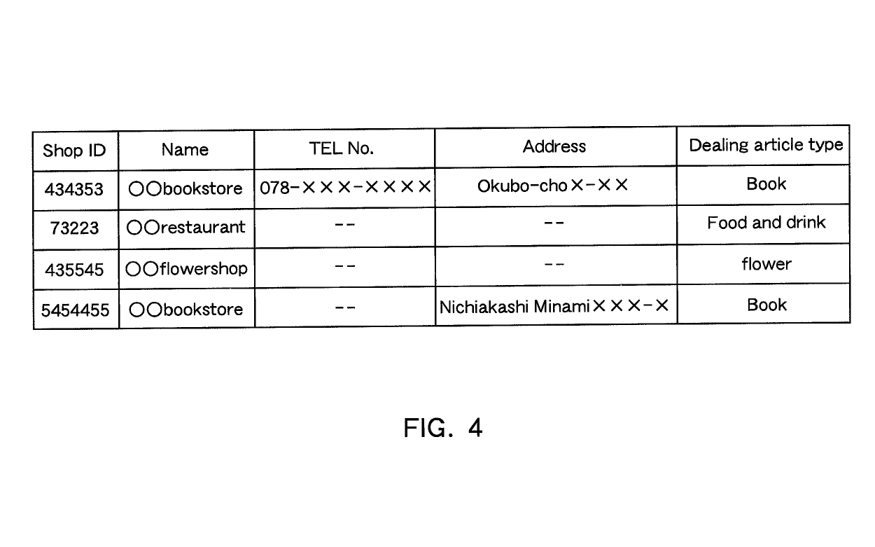

The shop searching part 120 gets access to the shop database 121, and searches for shops which can sell an article to prospective customers, based on the attribute information regarding the shops and the article dealing information showing whether or not the shops deal in the article. FIG. 4 shows a data example held and registered in the shop database 121. The shop database 121 contains information such as a shop ID, a shop name, a TEL No., a shop address, article types dealt in by a shop, and the like. Furthermore, the shop database 121 may contain inventory information.

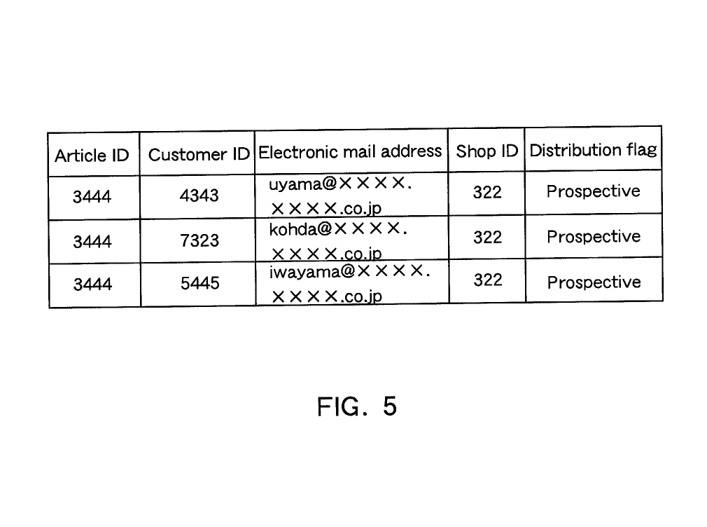

The prospective customer list generating part 130 generates a prospective customer list showing prospective customer information of which a prospective customer notifying part 210 notify the shop system 200. The prospective customer list refers to a list of prospective customers arranged on a shop basis, and contains customer IDs. FIG. 5 shows a data example of a list showing prospective customer information generated by the advertisement distribution prospect customer list generating part 130. In this example, each data in the prospective customer list contains information on an article ID, a customer ID, an electronic mail address, a shop ID, and a distribution attribute. The attribute values of the distribution attribute include four states: a “prospective” state, a “regular” state, a “distribution completed” state, and a “distribution prohibited” state.

Herein, a “prospective” flag refers to flag information representing a customer retrieved as the one who is expected to purchase an advertising article by the prospective customer searching part 110. It is noted that the flag information, which is a “prospective” flag originally, may be overwritten with a “regular” or “distribution prohibited” flag in the advertisement distribution selecting part 220 of the shop system 200, as described later. Furthermore, the “distribution completed” flag refers to that time represented by the starting time information in the advertisement distribution information database 111 has passed, and advertisement distribution has been completed by the advertisement distributing part 160, as described later. A list that has been selected by overwriting the distribution attribute information in the advertisement distribution selecting part 220 is referred to as an “advertisement distribution preliminary list”, as described later. In the present embodiment, an advertisement distribution preliminary list is provided for each shop. However, an advertisement distribution preliminary list merging targets for distributing advertisement of a plurality of shops may be used. In this case, instead of issuing advertisement for each shop, advertising articles are advertised at the same time on a nationwide scale or in a predetermined region, based on one advertisement distribution preliminary list. Advertisement based on an advertisement distribution preliminary list for each shop can replace conventional advertisement such as fliers distributed by shops themselves. Advertisement using an advertisement distribution preliminary list merging a plurality of shops can replace TV advertisement of a newly developed article, conducted by manufacturers.

The prospective customer list sending part 140 sends the prospective customer list generated by the prospective customer list generating part 130 to the shop system 200 through the communication interface 170. The prospective customer list thus sent is presented to the shop side in a prospective customer list presenting part 211 in the prospective customer notifying part 210 of the shop system 200. The processing on the shop system 200 side will be described later with reference to its structure.

The name-embedded advertisement generating part 150 embeds shop identity information for identifying a shop and a customized message, if any, for each customer in a predetermined portion of the advertisement data stored in the advertisement data storing part, to generate name-embedded advertisement. The message may contain a sales price of an article, discount information, or the like. Furthermore, a fixed message may be prepared.

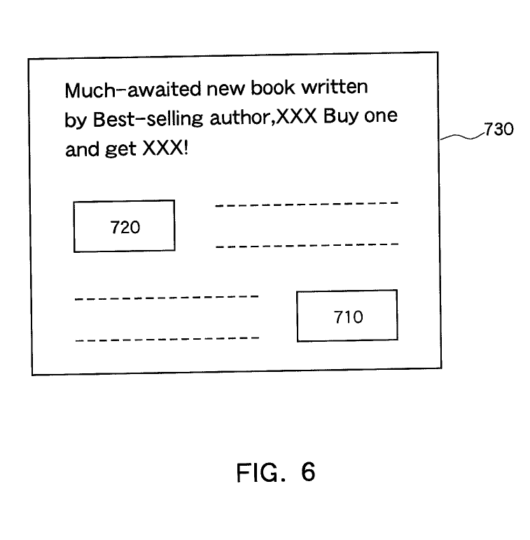

The advertisement data storing part 151 previously obtains and stores advertisement data for article advertisement provided by manufacturers or major sales dealers, which has not been subjected to name-embedding of a shop. FIG. 6 shows an advertisement data example stored in the advertisement data storing part 151. In FIG. 6, reference numeral 710 denotes a name-embedding portion for inputting shop identity information such as a shop name, a shop address, and a shop TEL No., 720 denotes customized information input portion for inputting a message customized for each customer, and 730 denotes an advertisement base portion that is a base for article advertisement containing the name-embedding portion 710 and the customized information input portion 720. If this advertisement data is used, name-embedded advertisement can be generated easily at a lower cost.

The advertising distributing part 160 receives an advertisement distribution preliminary list as the results of selection of advertisement distribution notified by an advertisement distribution selection result notifying part 230 of the shop system 200, and distributes name-embedded advertisement to the prospective customers with “prospective” flags in the received advertisement distribution preliminary list.

The processing in the advertisement distributing server 100 will be described later because it is synchronized with the processing in the shop system 200 in a processing flow of the entire advertisement distributing system. First, the components of the shop system 200 will be described.

The shop system 200 is placed in each shop, so that it can be synchronized with a POS system of a shop in an application. Furthermore, the shop system 200 may be a simple system, such as a portable terminal designed for an i-mode, capable of transmitting data through the network 300. In FIG. 1, reference numeral 210 denotes a prospective customer notifying part, 211 denotes a prospective customer list presenting part, 220 denotes an advertisement distribution selecting part, 221 denotes a selection input part, 222 denotes an advertisement distribution preliminary list generating part, and 230 denotes an advertisement distribution selection result notifying part.

The prospective customer notifying part 210 notifies the shop side of the prospective customer list sent from the prospective customer list sending part 140 of the advertisement distributing server 100. The shop side understands that the shop is expected to sell an advertising article and knows prospective customers who are to receive advertisement, based on the prospective customer list.

The prospective customer list presenting part 211 is included in the prospective customer notifying part 210. A display device may be a CRT monitor, or may be a liquid crystal display portion if the shop system 200 is a portable terminal. Furthermore, voice information and other multimedia information, as well as text information, may be presented on the display device.

The prospective customer list is provided with customer IDs of prospective customers arranged on a shop basis.

The advertisement distribution selecting part 220 allows the shop side to confirm the prospective customer list notified by the prospective customer notifying part 210 and to select whether or not article advertisement will be actually distributed to the respective prospective customers on the list, and generates an advertisement distribution preliminary list that specifies actual targets for distributing advertisement.

As described above, if advertisement to be distributed mainly contains contents for developing new customers, distributing advertisement containing the fixed contents to all the customers will cause confusion. Therefore, it is required to previously distinguish new prospective customers from regular customers, and to check whether or not the advertising contents to be sent are reasonable. Thus, prospective customers found by searching the customer database 400 are presented to the shop side as a prospective customer list, allowing the shop side to select prospective customers who are to receive advertisement.

The advertisement distribution selecting part 220 includes the selection input part 221 and the advertisement distribution preliminary list generating part 222.

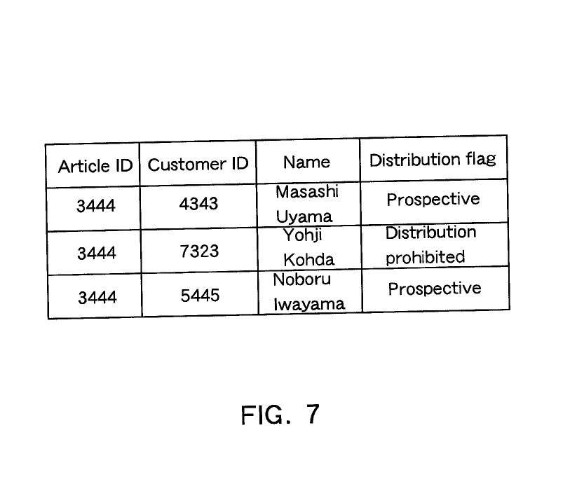

The selection input part 221 inputs the selection results of customers who are to receive advertisement in the prospective customer list. FIG. 7 shows an example of a selection method. FIG. 7 shows a state where prospective flags in the prospective customer list presented by the prospective customer list presenting part 211 are overwritten. In this example, among data in the prospective customer list in FIG. 5, information on an article ID, a customer ID, a name, and a distribution attribute are displayed, and a name is displayed in place of an electronic mail address. However, information to be displayed is not limited thereto. The attribute values of the distribution attribute include four states: a “prospective” state, a “regular” state, a “distribution completed” state, and a“distribution prohibited” state. The selection input part 221 includes means for updating the distribution attribute, and overwrites, among the “prospective” flags, those attached to regular customers (who have already purchased articles) and those attached to regular customers (to which distribution of advertisement is withheld and for which another distribution method is desired to use) with “regular” flags or “distribution prohibited” flags. It is also appreciated that update between other distribution attribute values may be possible, such as overwriting the “distribution prohibited” flags with the “regular” flags. The shop side decides to use the selection input part 221 to overwrite the prospective customer list in FIG. 5 with that in FIG. 7, whereby the flag attached to Mr. “Kohda” at the customer ID “7323” is rewritten from the “prospective” flag to the “distribution prohibited” flag.

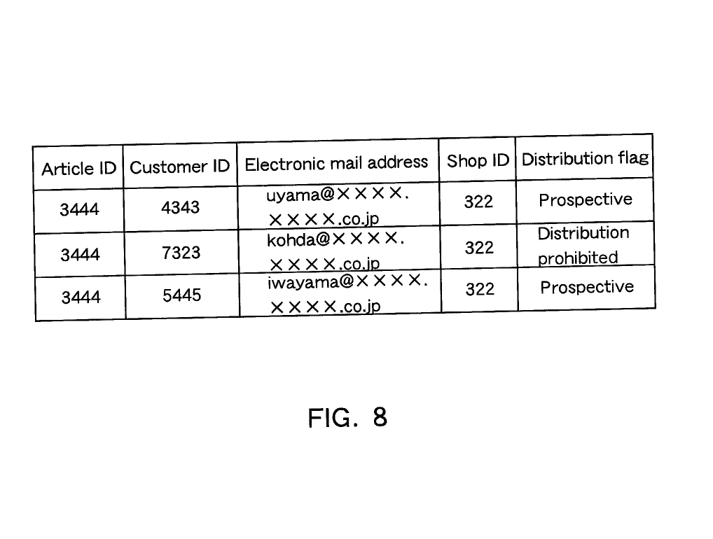

The advertisement distribution preliminary list generating part 222 rewrites the prospective customer list, reflecting the input of selection results from the selection input part 221, and generates an advertisement distribution preliminary list. FIG. 8 shows an example of the advertisement distribution preliminary list in which the distribution attribute attached to Mr. “Kohda” has been written.

The advertisement distribution selection result notifying part 230 sends the advertisement distribution preliminary list (generated by the advertisement distribution selecting part 220, reflecting the selection results of the shop side) to the advertisement distributing server 100. A timing at which the advertisement distribution selection result notifying part 230 sends an advertisement distribution preliminary list is variously assumed. In one example, immediately after overwriting of the distribution attribute is completed, an advertisement distribution preliminary list is sent. In another example, the advertisement distribution selection result notifying part 230 has a button for receiving a transmission instruction, such as a transmission button, and sends an advertisement distribution preliminary list in accordance with the input through the button. In still another example, information showing a distribution starting time of advertisement is supplied as an advertisement distribution starting requirement for each advertisement, and an advertisement distribution preliminary list is sent in accordance with the distribution starting time. Herein, an example of an advertisement distribution preliminary list including an advertisement distribution starting requirement will be described. In this case, the advertisement distribution selecting part 220 accepts selection of prospective customers via the selection input part 221 until the time represented by the advertisement distribution starting requirement, and the advertisement distribution selection result notifying part 230 sends an advertisement distribution preliminary list at that point to the advertisement distribution server 100 in accordance with the distribution staring time.

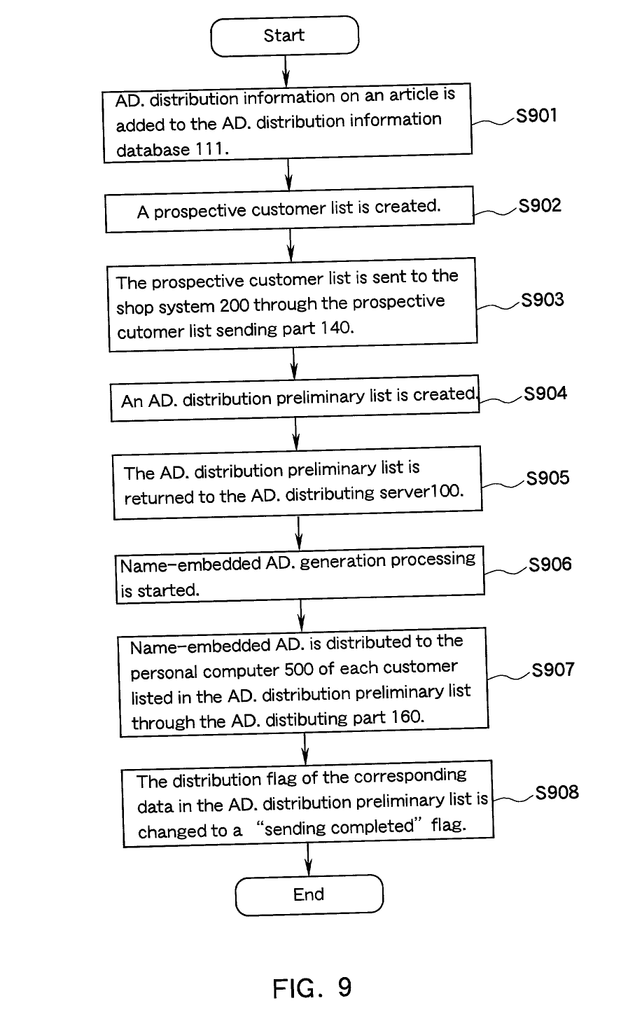

Next, a processing flow of the advertisement distributing system and method according to the present invention will be described with reference to a flow chart in FIG. 9. FIG. 9 is a flow chart schematically illustrating a processing flow of advertisement distribution in the case where new advertisement distribution information on a new article is added to the advertisement distribution information database 111 by a manufacturer.

As shown in FIG. 9, when new advertisement distribution information on a new article is added to the advertisement distribution information database 111 by a manufacturer (Operation 901), a procedure of creating a prospective customer list (Operation 902) is started.

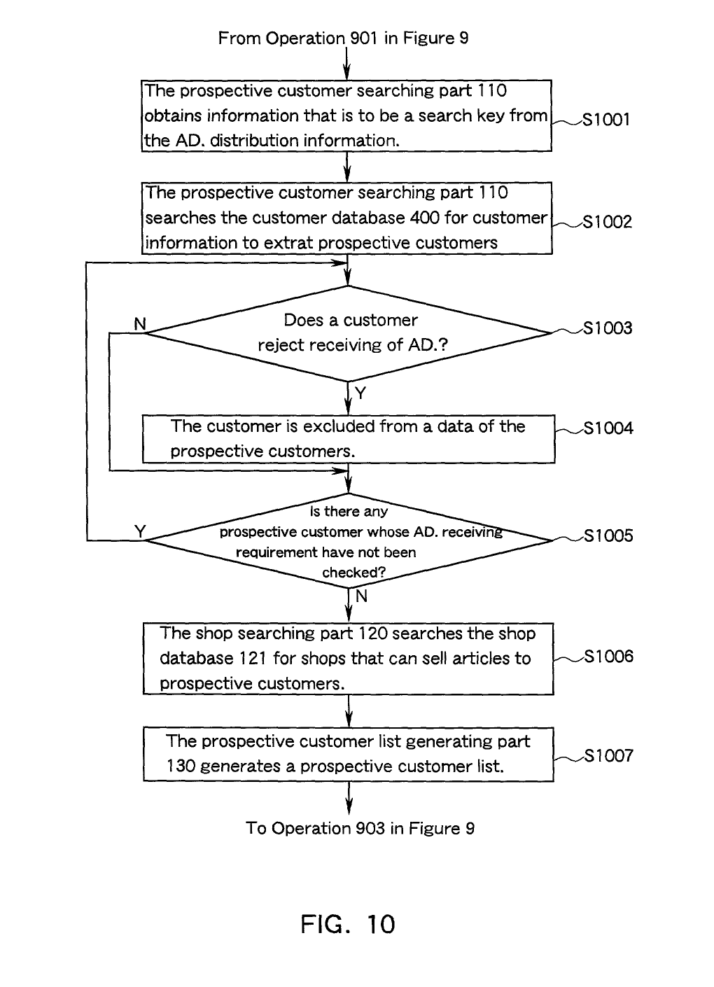

Herein, FIG. 10 shows a flow chart showing a detailed flow of the procedure of creating a prospective customer list (Operation 902).

As shown in FIG. 10, when the new advertisement distribution information on a new article is added to the advertisement distribution information database 111, the prospective customer searching part 110 obtains information that is to be a search key described in the advertisement distribution requirements from the advertisement distribution information (Operation 1001). In the advertisement distribution requirements, conditions of customers to which the shop side desires to distribute advertisement (e.g., “Age>12 AND Age<20 AND Gender=male”, is described.

The prospective customer searching part 110 searches the customer database 400 for customer information based on the search key to extract prospective customers (Operation 1002).

The prospective customer searching part 110 checks, for each customer, the advertisement receiving requirements regarding the receiving of advertisement contained in the advertisement distribution information (Operation 1003). In the case where the extracted prospective customers are to reject advertisement (Operation 1003: Y), those customers are excluded from a group of the selected prospective customers (Operation 1004). In the case where the extracted prospective customers are to accept advertisement (Operation 1003: N), those customers are left in a group of the selected prospective customers, and the process proceeds to next Operation 1005. It is investigated whether or not checking of the advertisement receiving requirements is completed with respect to all the prospective customers (Operation 1005). In the case where there are still prospective customers whose advertisement receiving requirements have not been checked (Operation 1005: Y), the process returns to Operation 1003, and checking of the advertisement receiving requirements is continued with respect to the remaining prospective customers. In the case where there are no prospective customers whose advertisement receiving requirements have not been checked (Operation 1005: N), the process proceeds to the next operation.

Next, the shop searching part 120 gets access to the shop database 121, and searches for shops that can sell articles to the prospective customers searched in Operation 1002, based on the attribution information and the article dealing information of shops (Operation 1006).

Next, the prospective customer list generating part 130 generates a prospective customer list containing information on an article ID, a customer ID, an electronic mail address, a shop ID, and a distribution attribute, based on the search results by the prospective customer searching part 110 and those by the shop searching part 120 (Operation 1007). For example, in this stage, distribution attribute values are prescribed to be prospective flags.

Referring to FIG. 9 again, the prospective customer list created by the procedure of creating a prospective customer list (Operation 902) is sent to the shop system 200 through the prospective customer list sending part 140 (Operation 903).

Next, a procedure of creating an advertisement distribution preliminary list is started (Operation 904).

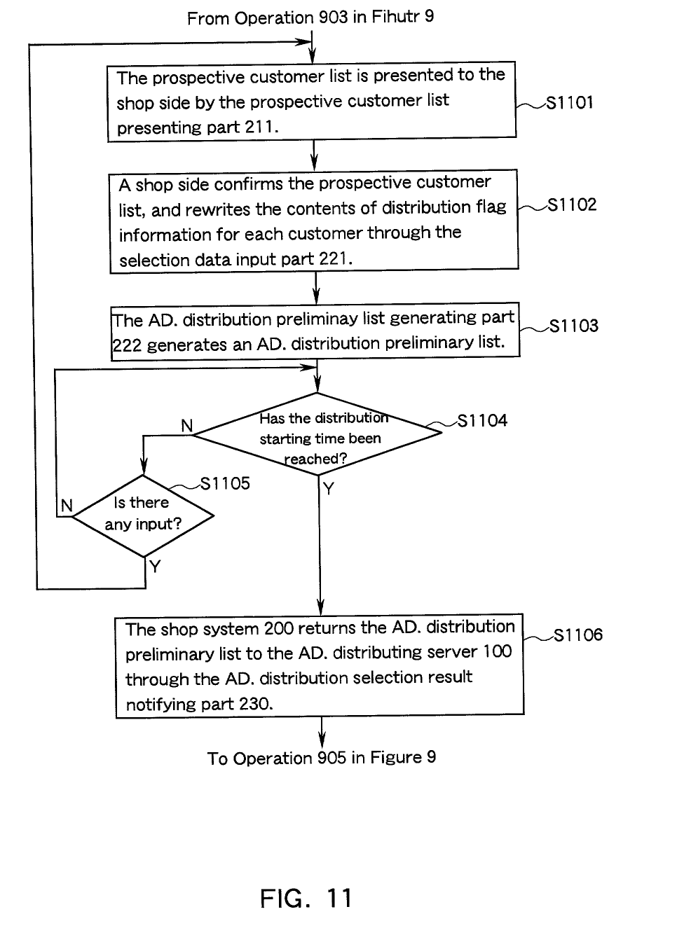

FIG. 11 shows a flow chart illustrating the procedure of creating an advertisement distribution preliminary list (Operation 904) in detail.

As shown in FIG. 11, the prospective customer list sent from the advertisement distribution server 100 is presented to the shop side by the prospective customer list presenting part 211 in the prospective customer notifying part 210 of the shop system 200 (Operation 1101).

A shop side confirms the prospective customer list notified by the prospective customer notifying part 210, and rewrites the contents of distribution attribute for each customer, if required, through the selection input part 221 (Operation 1102). For example, the shop rewrites the “prospective” flag attached to a regular customer to the “regular” flag. Because of rewriting of the distribution attribute, whether or not advertisement is distributed can be adjusted for each customer.

In Embodiment 1, a shop can input a message or the like customized to each customer. If there is a customized message, customized message information to the corresponding customers are also input if required.

Next, the advertisement distribution preliminary list generating part 222 receives the selection results in Operation 1102 to generate an advertisement distribution preliminary list (Operation 1103).

In Embodiment 1, an advertisement distribution time is adjusted. In the case where the shop system manages the advertisement distribution time, information on the advertisement distribution time should be sent to the shop system from the advertisement distributing server. The shop system checks the advertisement distribution starting requirements to confirm whether or not the distribution starting time has come (Operation 1104). Only in the case where the distribution starting time has come (Operation 1104: Y), the shop system 200 returns the advertisement distribution preliminary list to the advertisement distributing server 100 through the advertisement distribution selection result notifying part 230 (Operation 1106), and the process proceeds to Operation 905 in FIG. 9. In the case where the distribution starting time has come (Operation 1104: N), a waiting state is continued until an input is conducted (loop of Operation 1105: N and Operation 1104: N). When an input is conducted (Operation 1105: Y), the process returns to Operation 1101, whereby the latest prospective customer list is presented, and rewriting processing of distribution attribute is conducted, if required (Operation 1102). It is noted that the advertisement distribution time can also be managed by the advertisement distribution server side.

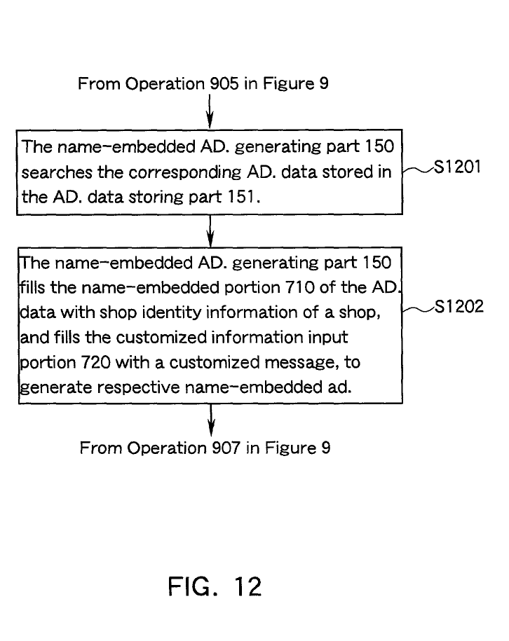

Referring to FIG. 9 again, the advertisement distribution preliminary list generated by the shop system 200 is returned to the advertisement distributing server 100 (Operation 905), and in the advertisement distributing server 100, name-embedded advertisement generation processing is started (Operation 906). Herein, FIG. 12 shows a flow chart illustrating the procedure of generating name-embedded advertisement (Operation 906).

First, the name-embedded advertisement generating part 150 checks advertisement IDs corresponding to the advertisement distribution preliminary list thus sent, and searches the advertisement data stored in the advertisement data storing part 151 for advertisement data of the article (Operation 1201).

The name-embedded advertisement generating part 150 fills the name-embedding portion 710 of the advertisement data with shop identity information such as a shop name, a shop address, and a shop TEL No. and fills the customized information input portion 720 with a customized message, if any, to generate name-embedded advertisement (Operation 1202).

Referring to FIG. 9 again, after generating name-embedded advertisement in Operation 906, name-embedded advertisement is distributed to the personal computer 500 of each customer listed in the advertisement distribution preliminary list through the advertisement distributing part 160 (Operation 907). Access information such as customer IDs and mail addresses of customers to which the “prospective” flags are attached in the advertisement preparing distribution list are investigated, and name-embedded advertisement thus prepared is distributed through the communication interface 170.

After distribution of advertisement is completed, the distribution attribute of the corresponding data in the advertisement distribution preliminary list is changed to the “distributed” (Operation 908).

As described above, according to the advertisement distributing system in Embodiment 1, prospective customers are extracted, using a large-scale customer database storing customer information managed by an Internet provider or the like, and whether or not advertisement should be distributed is minutely adjusted by a shop for each prospective customer, whereby electronic mail and banner advertisement can be distributed to customers through the Internet.

Embodiment 2

In Embodiment 2, an advertisement distributing system is described, in which an article to be advertised is selected by the shop side, prospective customers are extracted, using a large-scale customer database storing customer information managed by an Internet provider, and whether or not advertisement is to be distributed is minutely adjusted for each prospective customer.

In Embodiment 2, a shop system includes a terminal function of a POS system, and an article bar code is read by the POS terminal function, whereby an article to be advertised is selected.

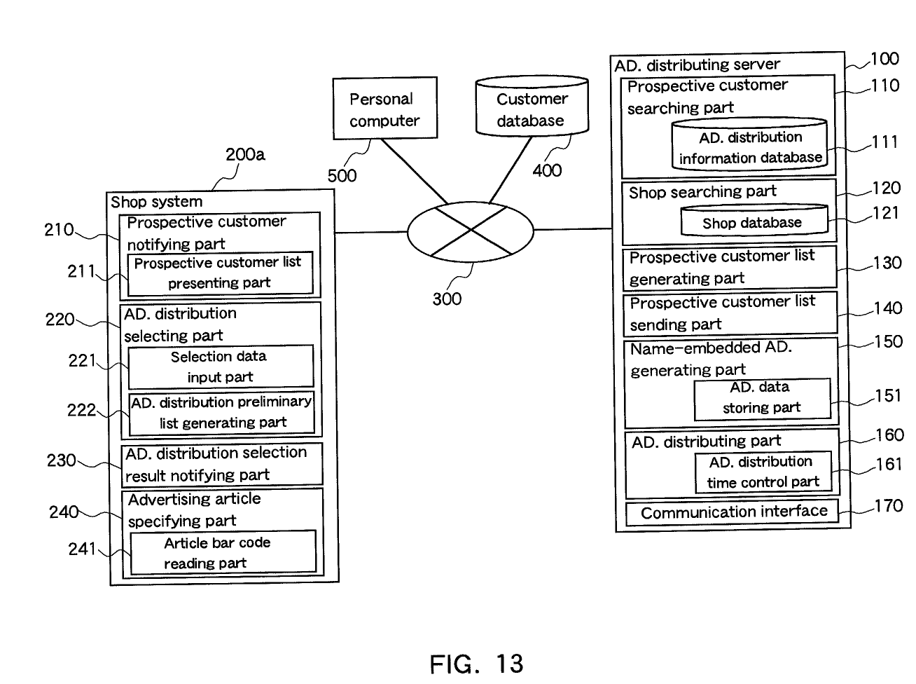

FIG. 13 is a block diagram showing an exemplary structure of the advertisement distributing system in Embodiment 2. In Embodiment 2, the structure of a shop system 200a is different from the shop system 200 in Embodiment 1 in the following components. In FIG. 13, respective elements of the shop system 200a: a prospective customer notifying part 210, a prospective customer list presenting part 211, an advertisement distribution selecting part 220, a selection put part 221, an advertisement distribution preliminary list generating part 222, and an advertisement distribution selecting result notifying part 230 are the same in structure as that of the shop system 200 in FIG. 1. The shop system 200a further includes an advertising article specifying part 240.

The advertising article specifying part 240 specifies a target article to be advertised as a sales promotion target article, based on the initiative of the shop side. In Embodiment 2, the advertising article specifying part 240 is provided with an article bar code reading part 241. The article bar code reading part 241 may be constructed using the article bar code reading function of the POS function included in the shop system 200a. For example, the advertising article specifying part 240 has a mode such as an “advertisement target article code input mode”, and operates the article bar code reading part 241 in this mode to read an article code for identifying an advertising article, such as a bar code attached to an article directly or a bar code printed on a catalog.

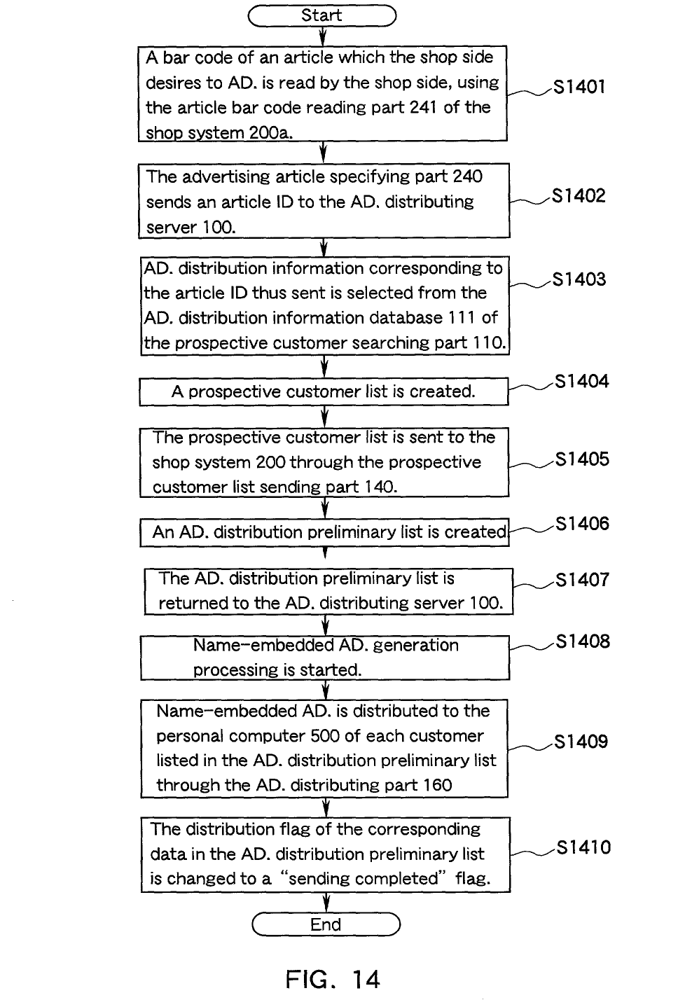

The processing flow of the advertisement distributing system in Embodiment 2 is substantially the same as that in Embodiment 1, except for processing of selecting an advertising article. As shown in FIG. 14, processing of selecting an advertising article in Operations 1401 to 1403 is different from Operation 901 in the flow chart in FIG. 9 described in Embodiment 1.

First, a bar code or the like of an article which the shop side desires to advertise is read by the shop side, using the article bar code reading part 241 of the shop system 200a (Operation 1401). Next, the advertising article specifying part 240 sends an article ID, such as an article code thus read, to the advertisement distributing server 100 (Operation 1402).

Next, advertisement distribution information corresponding to the article ID thus sent is selected from the advertisement distribution information database 111 of the prospective customer searching part 110 (Operation 1403).

Operation 1404 (i.e., procedure of creating a prospective customer list by the prospective customer searching part 110) to Operation 1410 (i.e., rewriting of distribution attribute after distributing name-embedded advertisement) correspond to Operations 902 to 908 in FIG. 9. Herein, the description thereof will be omitted.

As described above, according to the advertisement distributing system in Embodiment 2, an advertisement distribution target article can be selected based on the initiative of the shop side, prospective customers can be extracted using a large-scale customer database, with respect to the selected article, and whether or not advertisement is to be distributed can be minutely adjusted for each prospective customer.

Embodiment 3

According to an advertisement distributing system in Embodiment 3, whether or not advertisement is to be distributed is minutely adjusted with respect to customers extracted from a customer database managed by an Internet provider, the shop side adds regular customers, managed by a shop database of its own frequent shopper program, to the extracted customers, thereby adjusting overlapped customers, and thereafter, using advertisement data provided by a manufacture or a major sales dealer, name-embedded advertisement including a shop name is generated and sent to the customer group.

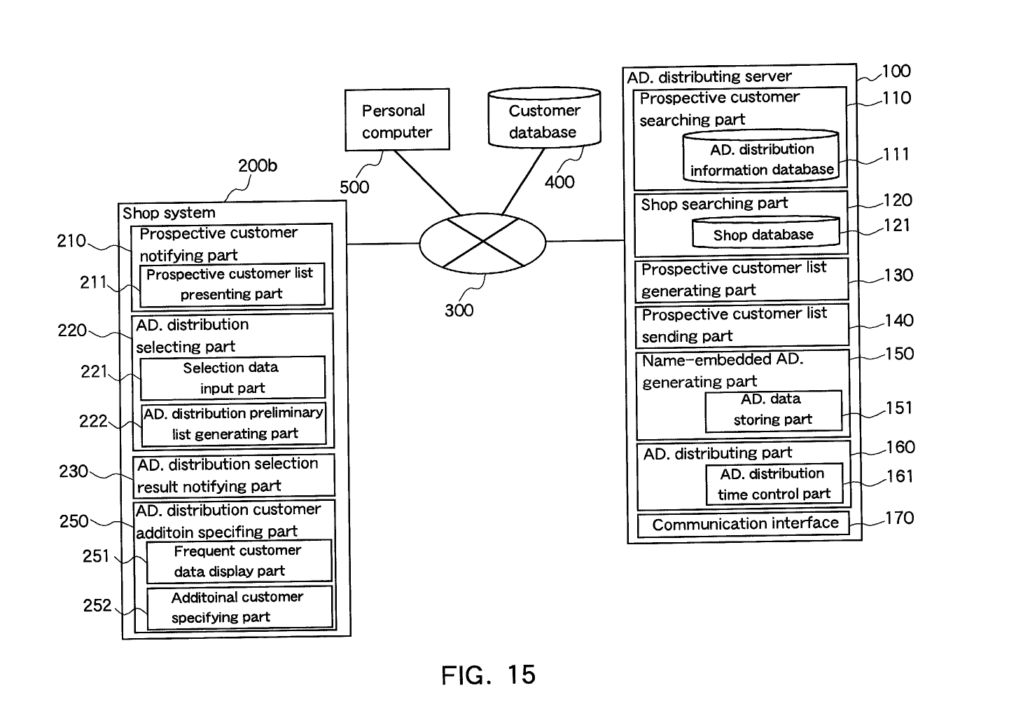

FIG. 15 shows an exemplary structure of an advertisement distributing system in Embodiment 3.

As shown in FIG. 15, a shop system 200b includes a prospective customer notifying part 210, a prospective customer list presenting part 211, an advertisement distribution selecting part 220, an advertisement distribution selection result notifying part 230, and an advertisement distribution customer adding part 250. The advertisement distribution customer adding part 250 includes a frequent customer data display part 251 and an additional customer specifying part 252.

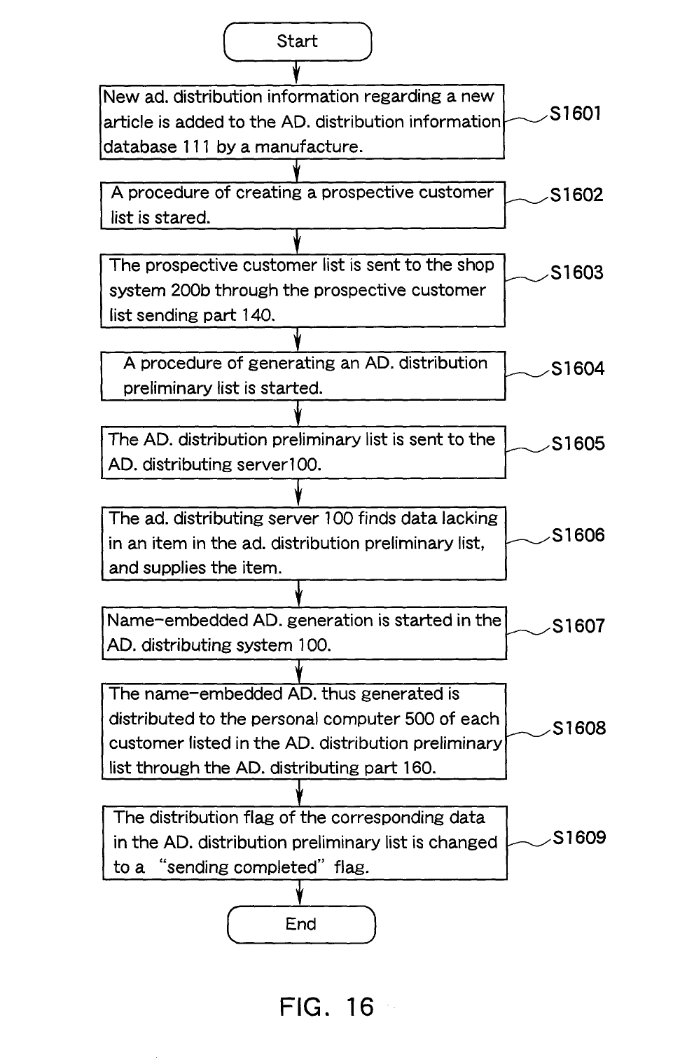

A processing flow of the advertisement distributing system in Embodiment 3 is shown in a flow chart in FIG. 16.

First, when new advertisement distribution information regarding a new article is added to the advertisement distribution information database 111 by a manufacture (Operation 1601), a procedure of creating a prospective customer list is started (Operation 1602). Operation 1602 may be the same as Operation 902 shown in FIG. 9 in Embodiment 1.

Next, the prospective customer list created in the procedure of creating a prospective customer list (Operation 1602) is sent to the shop system 200b through the prospective customer list sending part 140 (Operation 1603).

Next, a procedure of generating an advertisement distribution preliminary list is started (Operation 1604).

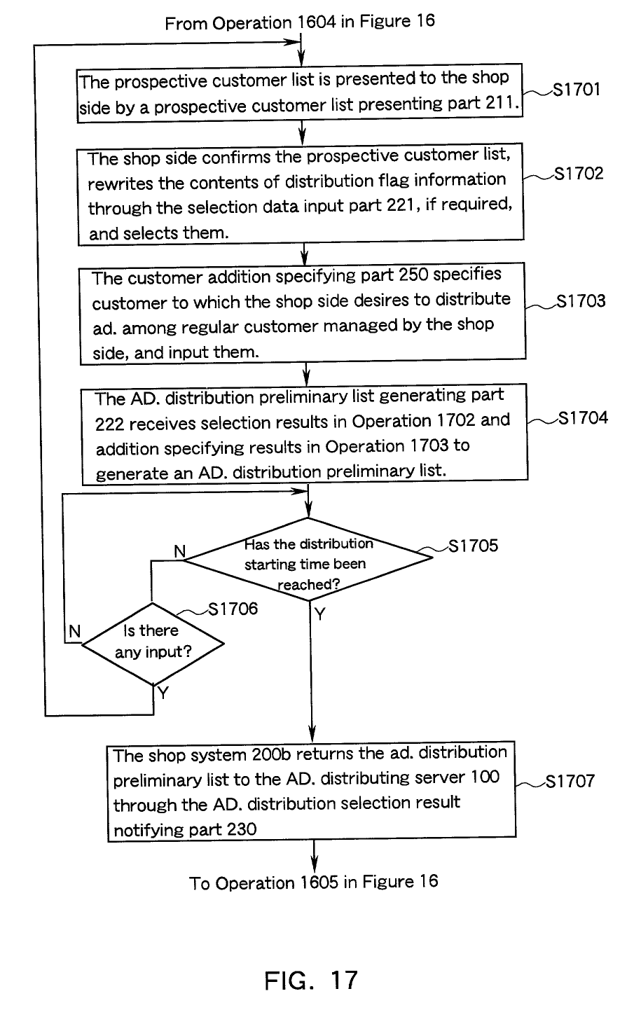

FIG. 17 shows a flow chart illustrating a detailed flow of the procedure of creating the advertisement distribution preliminary list (Operation 1604).

The prospective customer list sent from the advertisement distributing server 100 is presented to the shop side by the prospective customer list presenting part 211 in the prospective customer notifying part 210 of the shop system 200b (Operation 1701). The shop side confirms the prospective customer list notified by the prospective customer notifying part 210, rewrites the contents of distribution attribute information for each customer, if required, through the selection input part 221 of the advertisement distribution selecting part 220 (Operation 1702). In the present embodiment, it is also assumed that the distribution attribute of Mr. “Kohda” is rewritten from the “prospective” flag to the “distribution prohibited” flag, in the same way as described in Embodiment 1 with reference to FIG. 7.

Next, the advertisement distribution customer adding part 250 specifies customers to which the shop side desires to distribute advertisement, among regular customers managed by the shop side based on its own frequent shopper program (Operation 1703).

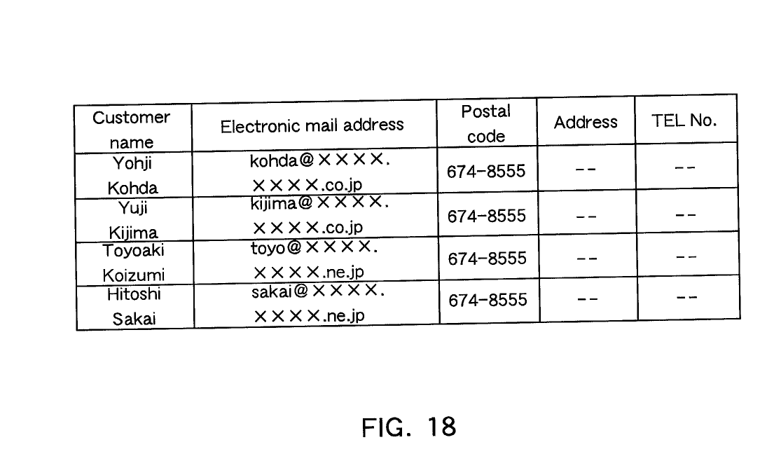

FIG. 18 shows a data example of a regular customer database of a frequent shopper program managed by the shop side. Attribute items may be dedicated items of the shop side, and is assumed to be different from attribute items of a large-scale customer database managed by an Internet provider shown in FIG. 3. In an example shown in FIG. 18, attribute items, such as a “customer name”, an “electronic mail address”, a “postal code”, an “address”, and a “TEL No.” are used. The frequent customer data display part 251 displays data contents shown in FIG. 18 as a list.

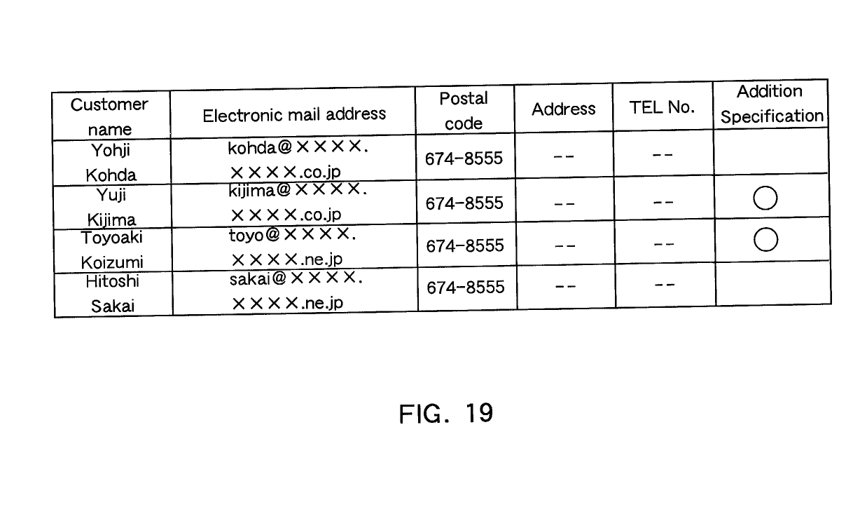

FIG. 19 shows a state where customers are being added through the additional customer specifying part 252 of the advertisement distribution customer adding part 250. As shown in FIG. 19, an addition specifying column is provided, and “addition” flags are placed in the addition specifying column of frequent customers which the shop side desires to add through the additional customer specifying part 252.

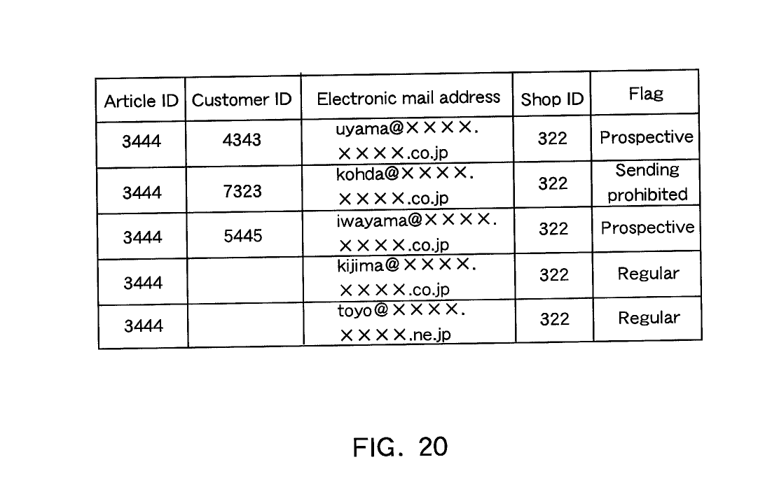

Next, the advertisement distribution preliminary list generating part 222 receives selection results in Operation 1702 and addition specifying results in Operation 1703 to generate an advertisement distribution preliminary list (Operation 1704). At this time, the advertisement distribution preliminary list generating part 222 merges additional prospective customers with the regular customers and adjusts overlapping therebetween. In the case of FIGS. 3 and 8, both the customers can be merged using an electronic mail address as a key. In the case where the additional customers cannot be completely merged with the regular customers due to a large number of attributes, the emphasis is placed on specifying overlapping customer information between the additional customers and the regular customers. FIG. 20 shows a state where the additional customers are merged with the regular customers to generate an advertisement distribution preliminary list. In this example, data on Mr. “Kijima” and Mr. “Imaizumi” specified for addition are added in the fourth and fifth lines of the advertisement distribution preliminary list. Mr. “Kijima” and Mr. “Imaizumi” are both specified for addition by the shop side, so that both of them are provided with “regular” flags.

In Embodiment 3, the advertisement distribution time control part 161 may be provided so as to control the advertisement distribution time. Operations 1705 to 1707 are the same as Operations 1104 to 1106 in the flow chart shown in FIG. 11. Therefore, the description thereof will be omitted here.

Next, the description will be continued referring to the flow chart in FIG. 16 again.

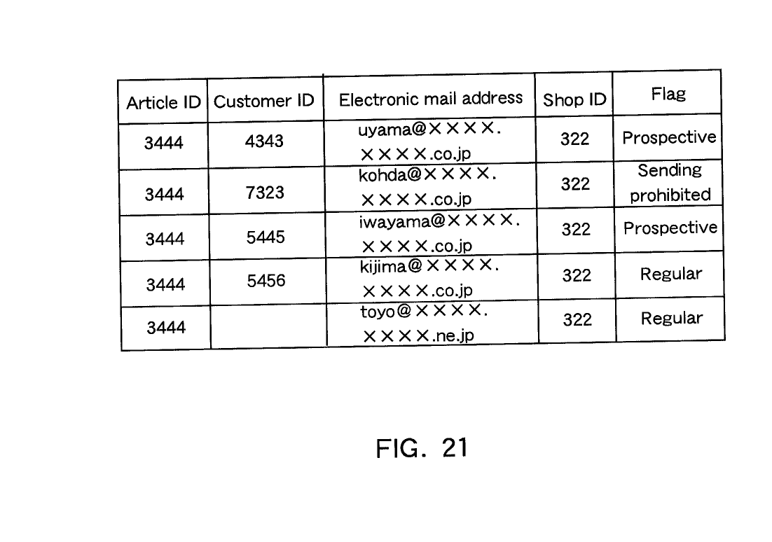

The generated advertisement distribution preliminary list is sent to the advertisement distributing server 100 (Operation 1605). The advertisement distributing server 100 finds data lacking in an item in the advertisement distribution preliminary list, and supplies the item (Operation 1606). In the stage of the advertisement preparing distribution list of the shop system 200b in FIG. 20, customer ID information on Mr. “Kijima” and Mr. “Imaizumi” specified to be added are lacking. This is because the customer ID information is given by the large-scale database 400, which the shop system 200b does not know. FIG. 21 shows an example in which data lacking in an item is supplied with the item in the advertisement distribution preliminary list.

In FIG. 21, customer ID information is supplied to the data on Mr. “Kijima”, whereas data on Mr. “Imaizumi” is still lacking in customer ID information. In this example, the customer information on Mr. “Kijima” is also managed by the large-scale database 400 managed by an Internet provider. Therefore, a customer ID “5456” of Mr. “Kijima” is automatically obtained and supplied, using, as a search key, an “electronic mail address” that is a common attribute between the customer information managed by the Internet provider and the customer information managed by the shop. On the other hand, the customer information on Mr. “Imaizumi” is not managed by the large-scale database 400, so that its customer ID information cannot be obtained.

In the advertisement distributing server 100, name-embedded advertisement generation is started (Operation 1607). The procedure flow of name-embedded advertisement generation is the same as that in Embodiment 1 described with reference to the flow chart of FIG. 12. Therefore, the description thereof will be omitted here. Advertisement for regular customers is generated based on advertisement data on regular customers and data regarding regular customers, and advertisement for prospective customers is generated based on advertisement data on prospective customers and data regarding prospective customers.

After name-embedded advertisement generation is conducted in Operation 1607, the name-embedded advertisement thus generated is distributed to the personal computer 500 of each customer listed in the advertisement distribution preliminary list through the advertisement distributing part 160 (Operation 1608). Access information such as customer IDs and mail addresses of customers provided with “regular” flags in the advertisement preparing distribution list is checked, and name-embedded advertisement for regular customers are distributed. On the other hand, access information such as customer IDs and mail addresses of customers provided with “prospective” flags in the advertisement preparing distribution list are checked, and name-embedded advertisement for prospective customers is distributed.

After distribution of advertisement is completed, the distribution attribute of the corresponding data in the advertisement distribution preliminary list is changed to a “distributed” flag (Operation 1609).

According to the advertisement distributing system in Embodiment 3, based on the initiative of the shop side, customers extracted from the customer database managed by an Internet provider are added to regular customers managed by a shop database of a frequent shopper program, and overlapping customers are adjusted to form a customer group. Name-embedded advertisement is generated using advertisement data provided by a manufacturer and a major sales dealer and sent to the customer group.

Embodiment 4

According to an advertisement distributing system in Embodiment 4, based on the initiative of the shop side, customers extracted from the customer database managed by an Internet provider are added to regular customers managed by a shop database of a frequent shopper program, and overlapping customers are adjusted to form a selected customer group. Name-embedded advertisement is generated using advertisement data provided by a manufacturer and a major sales dealer and sent to the customer group.

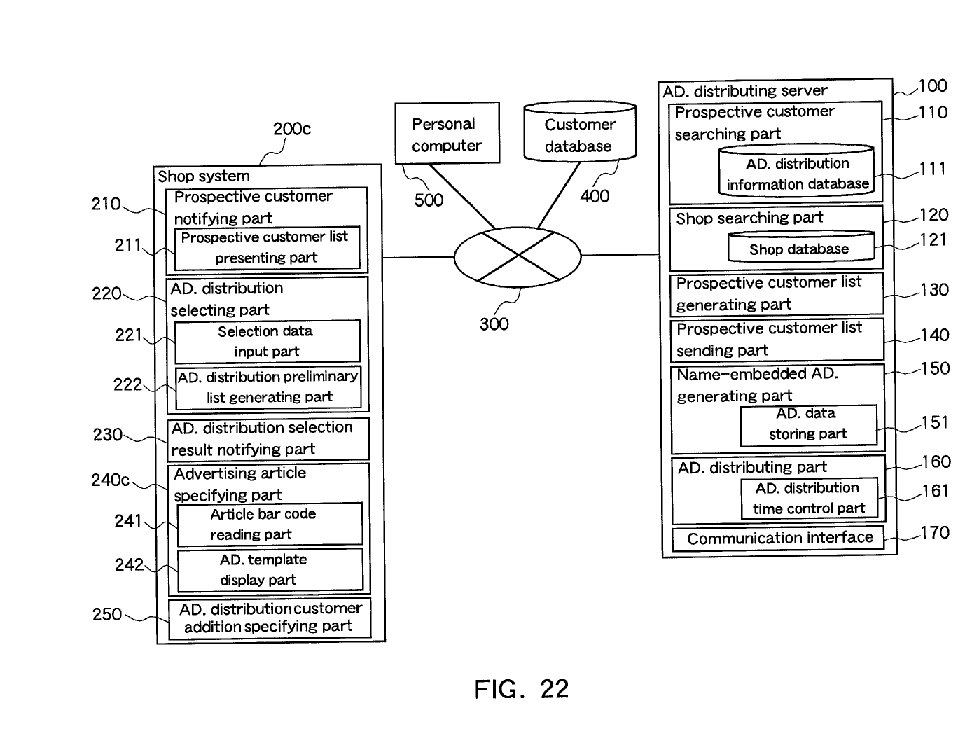

FIG. 22 shows an exemplary structure of the advertisement distributing system in Embodiment 4.

As shown in FIG. 22, a shop system 200c includes an advertisement target article specifying part 240c and an advertisement distribution customer adding part 250, as well as a prospective customer notifying part 210, a prospective customer list presenting part 211, an advertisement distribution selecting part 220, and an advertisement distribution selection result notifying part 230. The advertisement target article specifying part 240c includes an article bar code reading part 241 and an advertisement data display part 242.

The advertisement data display part 242 gets access to an advertisement data storing part 151 of a name-embedded advertisement generating part 150 of an advertisement distributing server 100 to display advertisement data. In Embodiment 4, an example of preparing advertisement data on regular customers and two kinds of advertisement data on prospective customers. It is assumed that a network 300 is the Internet, and an advertisement data display part 242 is provided with a browsing function of a worldwide web so as to browse through the advertisement data.

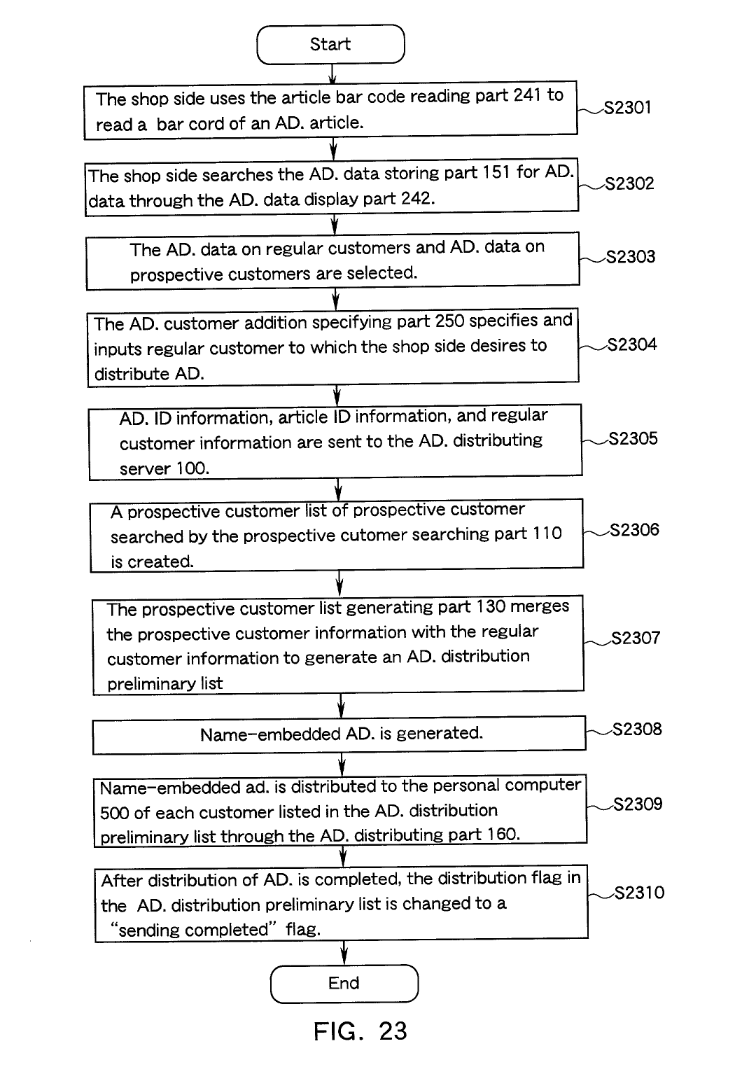

FIG. 23 is a flow chart showing a processing flow of the advertisement distributing system in Embodiment 4.

The shop side uses the article bar code reading part 241 of the shop system 200c to read a bar cord of an article which the shop side desires to advertise (Operation 2301).

The shop side gets access to the advertisement data storing part 151 of an advertisement distributing server 100 through the advertisement data display part 242 of the advertisement target article specifying part 240c to search for advertisement data (Operation 2302). In the case where there are a plurality of kinds of advertisement data, a preferable one is selected from them.

The advertisement data on regular customers and advertisement data on prospective customers are determined and selected (Operation 2303).

Next, the advertisement distribution customer adding part 250 specifies and inputs customers to which the shop side desires to distribute advertisement among the regular customers managed by the shop in its own frequent shopper program (Operation 2304).

Next, the shop system 200c sends the advertisement ID information on the advertisement data thus obtained, the article ID information on the advertising article, and customer information on the regular customers, to which advertisement is to be distributed, specified by the advertisement distribution customer adding part 250, to the advertisement distributing server 100 (Operation 2305).

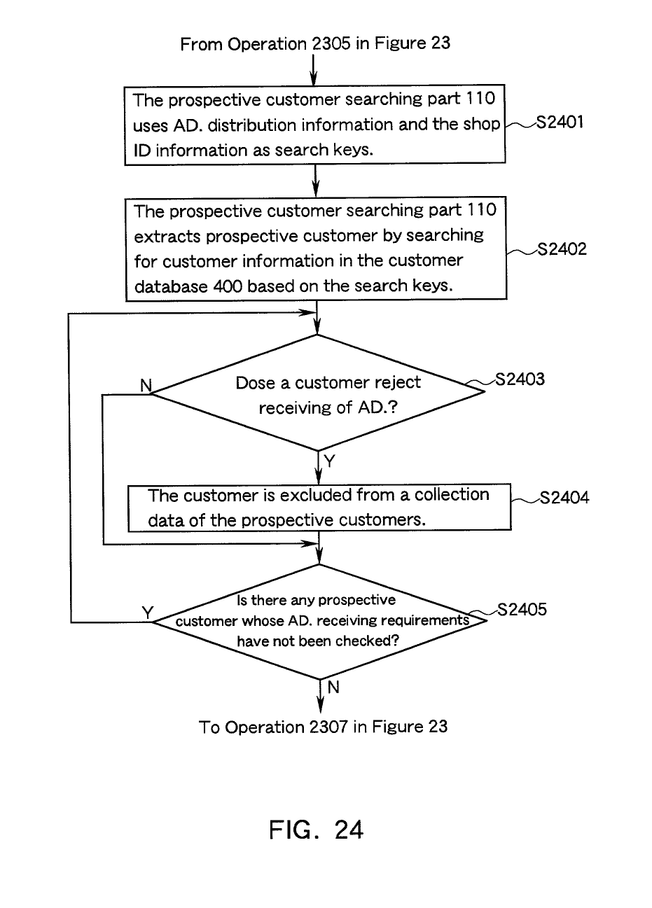

Next, the prospective customer searching part 110 conducts a procedure of creating a prospective customer list (Operation 2306). FIG. 24 is a flow chart showing a detailed procedure of creating a prospective customer list.

The prospective customer searching part 110 uses the advertisement distribution information and the shop ID information as search keys (Operation 2401). The prospective customer searching part 110 extracts prospective customers by searching for customer information in the customer database 400 based on the search keys (Operation 2402). Herein, since the shop ID information is also used as a search key, search is conducted for customers to which the shop can sell articles.

Operations 2403 to 2405 (checking of the advertisement receiving requirements by the prospective customer searching part 110 and removal of customers who reject receiving of advertisement) are similar to Operations 1003 to 1005 in FIG. 10. Thus, the description thereof will be omitted here.

Referring to FIG. 23 again, the prospective customer list generating part 130 merges the prospective customer information obtained as a result of search by the prospective customer searching part 110 with customer information on the regular customers specified by the advertisement distribution customer adding part 250 of the shop system 200c to generate an advertisement distribution preliminary list (Operation 2307). In the case where the prospective customer information cannot be completely merged with the regular customer information due to a large number of attributes, the emphasis is particularly placed on the overlapping customer information among both the customer information.

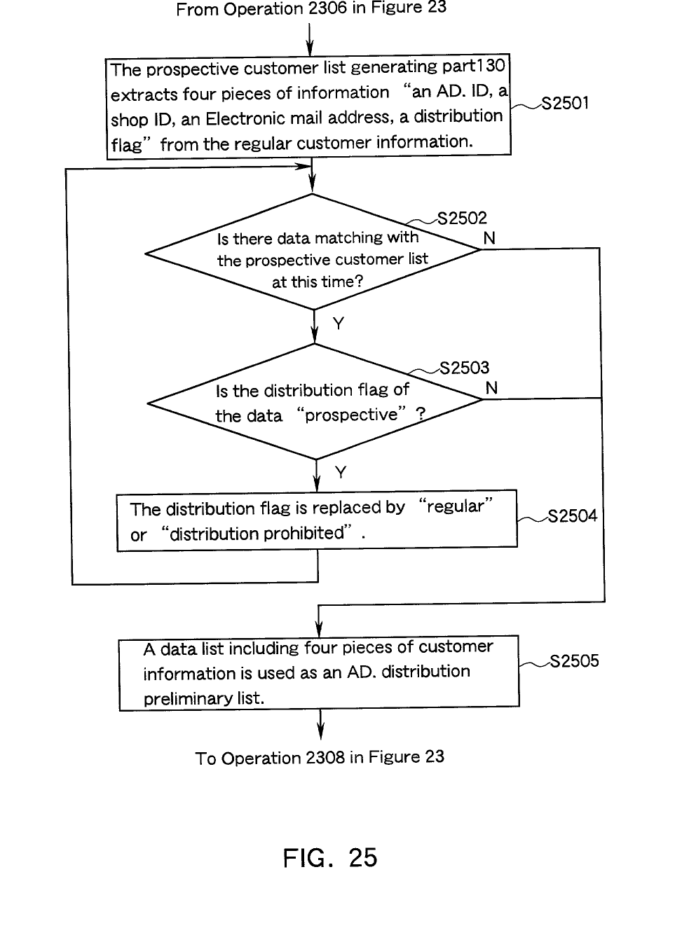

FIG. 25 is a flow chart showing a procedure of creating an advertisement distribution preliminary list in more detail (Operation 2307).

The prospective customer list generating part 130 extracts four pieces of information “an advertisement ID, a shop ID, an electronic mail address, a distribution attribute” from the regular customer information notified by the shop system 200c (Operation 2501), and checks if there is data matching with the prospective customer list at this time (Operation 2502). If there is matching data (Operation 2502: Y), it is checked if the distribution attribute of the data is “prospective” (Operation 2503). In the case where the distribution attribute is “prospective” (Operation 2503: Y), the distribution attribute is replaced by “regular” or “distribution prohibited” (Operation 2504). This processing corresponds to the case in Embodiment 1 where the selection input part 221 of the advertisement distribution selecting part 220 on the shop system 200 side overwrites the distribution attribute in the prospective customer distribution list searched and generated by the advertisement distributing server 100. After the distribution attribute is replaced, the process returns to Operation 2502.

If there is no matching data (Operation 2501: N), a data list including four pieces of customer information is used as an advertisement distribution preliminary list (Operation 2505).

In the advertisement distribution preliminary list thus generated, the case where data on electronic mail addresses of some customers are lacking can be assumed. In this case, the customer database 400 may be accessed to obtain data on electronic mail addresses of the customers, or the shop system 200c may be inquired about the data on electronic mail addresses of the customers.

Referring to the flow chart in FIG. 23 again, in the advertisement distributing server 100, name-embedded advertisement generation is started (Operation 2308). The flow of a procedure of generating name-embedded advertisement is the same as that in Embodiment 1 described with reference to the flow chart in FIG. 12, so that the description thereof will be omitted here. Advertisement data on regular customers is generated based on the advertisement data on regular customers and data regarding regular customers, and advertisement data on prospective customers is generated based on advertisement data on prospective customers and data regarding prospective customers.

After name-embedding generation is conducted in Operation 2308, name-embedded advertisement is distributed to the personal computer 500 of each customer listed in the advertisement distribution preliminary list through the advertisement distributing part 160 (Operation 2309). Access information such as customer IDs and mail addresses of customers provided with “regular” flags in the advertisement preparing distribution list is checked, and name-embedded advertisement for regular customers are distributed. On the other hand, access information such as customer IDs and mail addresses of customers provided with “prospective” flags in the advertisement preparing distribution list is checked, and name-embedded advertisement for prospective customers is distributed.

After distribution of advertisement is completed, the distribution attribute of the corresponding data in the advertisement distribution preliminary list is changed to “distributed” flags (Operation 2310).

According to the advertisement distributing system in Embodiment 4, based on the initiative of the shop side, customers extracted from the customer database managed by an Internet provider are added to regular customers managed by a selected shop database of a frequent shopper program, and overlapping customers are adjusted to form a customer group. Name-embedded advertisement is generated using advertisement data provided by a manufacturer and a major sales dealer and sent to the customer group.

Embodiment 5

Embodiment 5 discloses an advertisement distributing system and method, which uses a process of billing for distribution of name-embedded advertisement, and a process of a fee payment for utilizing advertisement service with respect to sales performance by the name-embedded advertisement.

According to the present invention, various methods of billing for generation and distribution of name-embedded advertisement are assumed. However, herein, an example will be described in which a manufacturer or a major sales dealer becomes an advertisement provider (i.e., an advertisement sponsor) to provide an advertisement fee for every distribution of name-embedded advertisement by the advertisement distributing system, and an entity handling and managing an advertisement distributing server obtains an advertisement fee. Furthermore, an example will be described in which an advertisement distributing shop fee is provided to a shop so as to give the shop an incentive for distributing name-embedded advertisement.

In Embodiment 5, a process of a fee payment for utilizing advertisement service is also disclosed in the case where distribution of name-embedded advertisement has led to sales performance. Various methods for determining the flow of a fee for sales performance are also assumed. However, herein, an example will be described in which an advertisement provider provides a sales fee and an entity handling and managing an advertisement distributing server obtains a sales fee. Furthermore, an example will be described in which a sales fee is provided to a shop so as to give the shop an incentive.

First, a process of billing for distribution of name-embedded advertisement will be described.

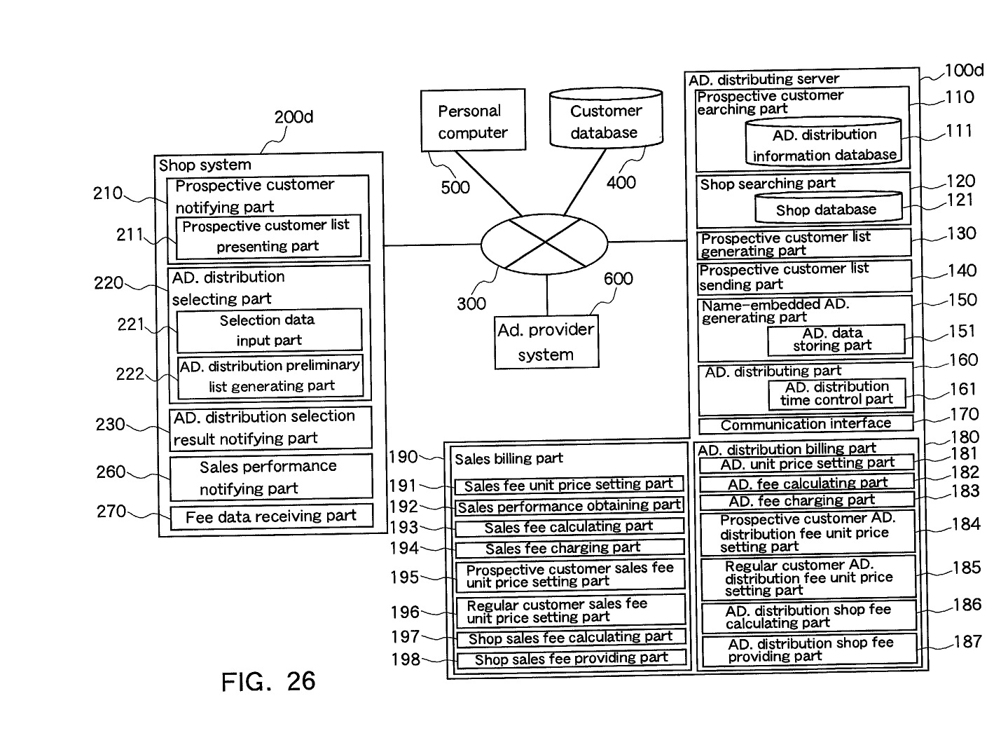

FIG. 26 schematically shows an exemplary structure of the advertisement distributing system in Embodiment 5.

Reference numeral 600 denotes a system of a manufacturer or a major sales dealer (advertisement provider system), managed by an advertisement provider distributing advertisement.

The advertisement distributing server 100d further includes an advertisement distribution billing part 180 and a sales billing part 190, in addition to the structure of the advertisement distributing server 100 in Embodiment 1. The advertisement distribution billing part 180 includes an advertisement unit price setting part 185, an advertisement fee calculating part 182, an advertisement fee charging part 183, a prospective customer advertisement distribution fee unit price setting part 184, a regular customer advertisement distribution fee unit price setting part 185, an advertisement distribution shop fee calculating part 186, and an advertisement distribution shop fee providing part 187. The sales billing part 190 includes a sales fee unit price setting part 191, a sales performance obtaining part 192, a sales fee calculating part 193, a sales fee charging part 194, a prospective customer sales fee unit price setting part 195, a regular customer sales fee unit price setting part 196, a shop sales fee calculating part 197, and a shop sales fee providing part 198.

The advertisement unit price setting part 181 inputs and sets an advertisement unit price for billing per advertisement with respect to an advertisement provider of article advertisement.

The advertisement calculating part 182 calculates an advertisement fee by multiplying the advertisement unit price set in the advertisement unit price setting part 181 by the number of name-embedded advertisements generated in the name-embedded advertisement generating part 150. More specifically, the advertisement calculating part 182 calculates an advertisement fee=(advertisement unit price)×(number of name-embedded advertisements).

The advertisement fee charging part 183 charges, to the advertisement provider, the advertisement fee calculated by the advertisement fee calculating part 182. For example, the advertisement provider system 600 is notified of and charged the advertisement fee through the communication interface 170.

The prospective customer advertisement distribution fee unit price setting part 184 inputs and sets a unit price of a prospective customer advertisement distribution fee provided to a customer name-embedded advertisement for prospective customers.

The regular customer advertisement distribution fee unit price setting part 185 inputs and sets a unit price of a regular customer advertisement distribution fee provided to a customer name-embedded advertisement for regular customers.

The advertisement distribution shop fee calculating part 186 calculates a total fee obtained by multiplying the prospective customer advertisement distribution fee unit price set by the prospective customer advertisement distribution fee unit price setting part 184 by the number of name-embedded advertisements for prospective customers generated by the name-embedded advertisement generating part 150 and a fee obtained by multiplying the regular customer advertisement distribution fee unit price set by the regular customer advertisement distribution fee unit price setting part 185 by the number of name-embedded advertisements for regular customers generated by the name-embedded advertisement generating part 150, thereby calculating an advertisement distribution shop fee. More specifically, the advertisement distribution shop fee calculating part 186 calculates an advertisement distribution shop fee =(prospective customer advertisement distribution fee unit price)×(number of name-embedded advertisements for prospective customers)+(regular customer advertisement fee unit price)×(number of name-embedded advertisements for regular customers).

The advertisement distribution shop fee providing part 187 provides the advertisement distribution shop fee calculated by the advertisement distribution shop fee calculating part 186 to a shop. For example, the shop system 200d is notified of the advertisement distribution shop fee through the communication interface 170, whereby the shop is provided with the fee.

The sales fee unit price setting part 191 inputs and sets a sales fee unit price for billing per sales performance of an article with respect to the advertisement provider system 600.

The sales performance obtaining part 192 collects and obtains sales performance of the articles sold to the customers that have received advertisement. The sales performance is obtained as sales performance data on the articles for each shop system 200d connected to the advertisement distributing system 100d through the network 300. It is preferable to obtain sales performance data in the case where customers who have received advertisement, visited a shop, and purchased articles. It is possible to easily obtain sales performance data in conjunction with the POS function of the shop system 200d.

The sales fee calculating part 193 calculates a sales fee by multiplying the sales fee unit price set by the sales fee unit price setting part 191 by the sales volume collected and obtained by the sales performance obtaining part 192. More specifically, the sales fee calculating part 193 calculates a sales fee=(sales fee unit price)×(sales volume).

The sales fee charging part 194 charges a sales fee calculated by the sales fee calculating part 193 to an advertisement provider. For example, the advertisement provider system 600 is notified of and charged a sales fee through the communication interface 170.

The prospective customer sales fee unit price setting part 195 inputs and sets a unit price of a shop sales fee provided to a customer sales performance for prospective customers.

The regular customer sales fee unit price setting part 196 inputs and sets a shop sales fee provided to a customer sales performance for regular customers.

The shop sales fee calculating part 197 calculates a total fee obtained by multiplying a prospective customer sales fee unit price set by the prospective customer sales fee unit price setting part 195 by the sales volume with respect to the prospective customers obtained by the sales performance obtaining part 192 and a fee obtained by multiplying the sales volume with respect to the regular customers obtained by the sales performance obtaining part 192 by the regular customer sales fee unit price set by the regular customer sales fee unit price setting part 196. More specifically, the shop sales fee calculating part 197 calculates a shop sales fee=(prospective customer sales fee unit price)×(sales volume with respect to prospective customers)+(regular customer sales fee unit price)×(sales volume with respect to regular customers).

The shop sales fee providing part 198 provides a shop sales fee calculated by the shop sales fee calculating part 197. For example, the shop system 200d is notified of a shop sales fee through the communication interface, whereby the shop is provided with the fee.

The shop system 200d includes a sales performance notifing part 260 and a fee data receiving part 270 in addition to the shop system 200 described in Embodiment 1.

The sales performance notifying part 260 notifies the advertisement distributing server 100d of the sales volume that is to be the base for calculating a sales fee and a shop sales fee through the shop system 200d. Since the sales volume to be notified is obtained by evaluating the sales performance increased due to distribution of advertisement, it is preferable that the sales volume to be notified is obtained as the number of the articles actually purchased by customers who have received advertisement and visited a shop. Furthermore, it is possible to easily extract and obtain the number of the articles purchased by customers who have become targets for distributing advertisement based on customer IDs and visited a shop, in conjunction with the POS function of the shop system 200d.

The fee data receiving part 270 receives advertisement distribution shop fee data and shop sales fee data from the advertisement distribution shop fee providing part 187 and the shop sales fee providing part 198 from the advertisement distributing server 100d.

Due to the above-mentioned structure, according to the advertisement distributing system and method in Embodiment 5, a process of billing for distribution of name-embedded advertisement is provided. Furthermore, according to the advertisement distributing system and method in Embodiment 5, a process of a fee payment for utilizing advertisement service and the like with respect to the sales performance by name-embedded advertisement is provided.

Thus, there has been provided a description that an advertisement distribution shop fee or a shop sales fee is given as an incentive for a shop. However, it may also be possible to set the calculated values as minus values and collect a fee from the shop side based on the values.

Embodiment 6

The advertisement distributing system of the present invention can be constructed using various computers, by providing a program describing processing steps of realizing the above-mentioned structure recorded on a computer-readable recording medium. Examples of the recording medium storing a program describing the processing steps of implementing the advertisement distributing system of the present invention include a recording medium 1000 in a data storage apparatus on a network and a recording medium 1005 such as a hard disk and an RAM of a computer, as well as a portable recording medium 1001 such as a CD-ROM 1002 and a flexible dick 1003. In execution of the program, the program is loaded onto the computer 1004 and executed on a main memory.

Regarding the advertisement distributing system of the present invention, the following is disclosed.

According to the advertisement distributing system and method of the present invention, prospective customers are extracted, using a large-scale customer database storing customer information managed by an Internet provider or the like, and whether or not advertisement should be distributed is minutely adjusted by a shop for each prospective customer, whereby electronic mail and banner advertisement can be distributed to customers through the Internet.

Furthermore, according to advertisement distributing system and method of the present invention, an advertisement distribution target article can be selected based on the initiative of the shop side, prospective customers can be extracted using a large-scale customer database, with respect to the selected article, and whether or not advertisement is to be distributed can be minutely adjusted for each prospective customer.

According to the advertisement distributing system and method of the present invention, based on the initiative of the shop side, customers extracted from the customer database managed by an Internet provider are added to regular customers managed by a shop database of a shop's frequent shopper program, and overlapping customers are adjusted to form a customer group. Name-embedded advertisement is generated using advertisement data provided by a manufacturer or a major sales dealer and sent to the customer group.

According to the advertisement distributing system and method of the present invention, there is provided a process of billing for distribution of name-embedded advertisement. Furthermore, there is provided a process of a fee payment for utilizing advertisement service and the like with respect to the sales performance by name-embedded advertisement.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A method for distributing advertisement, comprising:
a prospective customer searching operation of searching for prospective customers of an advertising article from customer information;
a shop searching operation of searching for shops that are capable of selling the article to the prospective customers from shop information;
a prospective customer notifying operation of creating a prospective customer list of the prospective customers, to which the shops are capable of selling the article, on a shop basis, and notifying the shops of the list;
an advertisement distribution selecting operation of allowing the shops to determine whether or not advertisement regarding the article is to be distributed to the prospective customers in the notified prospective customer list;
a name-embedded advertisement generating operation of generating name-embedded advertisement in which shop identity information capable of identifying the shops is added to the advertisement previously registered; and
a name-embedded advertisement distributing operation of distributing the name-embedded advertisement to the prospective customers selected to receive the name-embedded advertisement in the advertisement distribution selecting operation.

2. A method for distributing advertisement, comprising:
an advertisement target article specifying operation of specifying an article which a shop desires to advertise;
a prospective customer searching operation of searching for prospective customers of the article from customer information;
an advertisement distribution selecting operation of allowing the shop to determine whether or not advertisement regarding the article is to be distributed to the prospective customers in the searched prospective customer list;
a name-embedded advertisement generating operation of generating name-embedded advertisement in which shop identity information capable of identifying the shop is added to the advertisement previously registered; and
a name-embedded advertisement distributing operation of distributing the name-embedded advertisement to the prospective customers selected to receive the advertisement in the advertisement distribution selecting operation.

3. A method for distributing advertisement, comprising:
an advertising article specifying operation in a shop;
a regular customer selecting operation of allowing the shop to determine whether or not advertisement regarding the article is to be distributed to each regular customer, based on regular customer information;
a prospective customer searching operation of searching for prospective customers to which the shop is capable of selling the article, and creating a prospective customer list;
a regular customer addition operation of generating an advertisement distribution preliminary list by excluding the customers, who have selected not to receive the advertisement in the regular customer selecting operation, from the prospective customer list, and by adding the regular customers selected to receive the advertisement in the regular customer selecting operation;
a name-embedded advertisement generating operation of generating name-embedded advertisement in which shop identity information capable of identifying the shop is added to the advertisement; and
name-embedded advertisement distributing operation of distributing the name-embedded advertisement to customers in the advertisement distribution preliminary list.

4. A method for distributing advertisement according to claim 3, comprising an advertisement distribution billing operation including:
an advertisement unit price setting operation of setting an advertisement unit price for billing an advertisement provider per advertisement with respect to the advertisement of the article;
a prospective customer distribution fee unit price setting operation of setting a unit price of a prospective customer distribution fee provided to a shop per distribution to prospective customers;
a regular customer distribution fee unit price setting operation of setting a unit price of a regular customer distribution fee provided to a shop per distribution to regular customers;
an advertisement fee calculating operation of calculating an advertisement fee by multiplying the advertisement unit price by the number of name-embedded advertisements distributed in the name-embedded advertisement distributing operation;
an advertisement fee charging operation of charging the advertisement fee to the advertisement provider; and
an advertisement distribution shop fee providing operation of providing an advertisement distribution shop fee calculated by adding a product obtained by multiplying the prospective customer distribution fee unit price by the number of name-embedded advertisements distributed to the prospective customers, to a product obtained by multiplying the regular customer distribution fee unit price by the number of name-embedded advertisements distributed to the regular customers.

5. A method for distributing advertisement according to claim 3, comprising a sales billing operation including:
a sales fee unit price setting operation of setting a sales fee unit price for billing the advertisement provider per sales performance;
a sales performance obtaining operation of obtaining a sales volume of the article sold to customers who have received the advertisement;
a prospective customer sales fee unit price setting operation of setting a unit price of a prospective customer sales fee provided to a customer sales performance with respect to the prospective customers;
a regular customer sales fee unit price setting operation of setting a unit price of a regular customer sales fee provided to the customer sales to the regular customers;
a sales fee calculating operation of calculating a sales fee by multiplying the sales fee unit price by the sales volume obtained in the sales performance obtaining operation; and
a shop sales fee providing operation of providing an advertisement distribution shop fee calculated by adding a product obtained by multiplying the prospect customer sales fee unit price by the sales volume with respect to the prospective customers, to a product obtained by multiplying the regular customer sales fee unit price by the sales volume with respect to the regular customers.

6. A method for distributing advertisement, comprising:
a prospective customer searching operation of searching for prospective customers of an advertising article from customer information, based on article attribute information, attribute information on customers, and advertisement receiving requirements regarding acceptance/rejection of receiving advertisement set for each customer;
a shop searching operation of searching for shops that can sell the article to the prospective customers, based on shop attribute information, and article dealing information representing whether or not the shops deal in the article;
a prospective customer notifying operation of creating a prospective customer list of the prospective customers to which the shops can sell the article on a shop basis, and notifying each shop of the list;
an advertisement distribution selecting operation of allowing a shop to select whether or not advertisement regarding the article is to be distributed to the prospective customers in the notified prospective customer list;
a name-embedded advertisement generating operation of generating name-embedded advertisement in which shop identity information capable of identifying the shop is added to the advertisement previously registered; and
name-embedded advertisement distributing operation of distributing the name-embedded advertisement to the prospective customers selected to receive the name-embedded advertisement in the advertisement distribution selecting operation.

7. A method for distributing advertisement according to claim 6, wherein the advertisement distribution selecting operation includes: a prospective customer list presenting operation of presenting a prospective customer list including prospective customers for each shop to the shop; a selection input operation of selecting whether or not advertisement of the article is to be distributed to the prospective customers, based on the prospective customer list; and an advertisement distribution preliminary list generating operation of generating an advertisement distribution preliminary list that specifies distribution destinations of the advertisement, based on results of the selection input operation.

8. A method for distributing advertisement according to claim 6, wherein information representing a distribution starting time of the advertisement is prescribed to be an advertisement distribution starting requirement,
in the advertisement distribution selecting operation, selection of the prospective customers is accepted until the time represented by the advertisement distribution starting requirement, and
on the time represented by the advertisement distribution starting requirement, the name-embedded advertisement generating operation and the name-embedded advertisement distributing operation are conducted.

9. A method for distributing advertisement according to claim 6, wherein the name-embedded advertisement generating operation includes an advertisement data obtaining operation of previously obtaining advertisement data for the advertisement in which name-embedding of a shop has not been completed and a shop name-embedding operation of embedding information on the shop in the advertisement data.

10. A method for distributing advertisement according to claim 6, including an advertisement distribution billing operation including: an advertisement unit price setting operation of setting an advertisement unit price for billing an advertisement provider per advertisement; an advertisement fee calculating operation of calculating an advertisement fee by multiplying the advertisement unit price by the number of name-embedded advertisements generated by the name-embedded advertisement generating operation; and an advertisement fee charging operation of charging the advertisement fee to the advertisement provider.

11. A method for distributing advertisement according to claim 10, wherein the advertisement distribution billing operation includes: an advertisement distribution shop fee unit price setting operation of setting a unit price of an advertisement distribution shop fee provided to a customer advertisement with respect to distribution of the name-embedded advertisement; an advertisement distribution shop fee calculating operation of calculating an advertisement distribution shop fee by multiplying the advertisement distribution fee unit price by the number of name-embedded advertisements generated by the name-embedded advertisement generating operation; and an advertisement distribution shop fee providing operation of providing the advertisement distribution shop fee to the shop.

12. A method for distributing advertisement according to claim 6 including a sales billing operation including: a sales fee unit price setting operation of setting a sales fee unit price for billing the advertisement provider per sales performance; a sales performance obtaining operation of obtaining a sales volume regarding the article sold to customers who have received the advertisement; a sales fee calculating operation of calculating a sales fee by multiplying the sales fee unit price by the sales volume obtained by the sales performance obtaining operation; and a sales fee charging operation of charging the sales fee to the advertisement provider.

13. A method for distributing advertisement according to claim 12, wherein the sales billing operation further includes: a shop sales fee unit price setting operation of setting a unit price of a shop sales fee provided to a customer sales performance; a shop sales fee calculating operation of calculating a shop sales fee by multiplying the shop sales fee unit price by the sales volume; and a shop sales fee providing operation of providing the shop sales fee to the shop.

14. An advertisement distributing system, comprising:
a prospective customer searching part for searching for prospective customers of an advertising article from a customer database;
a shop database storing shop information;
a shop searching part for searching for shops capable of selling the article to the prospective customers from the shop database;
a prospective customer list generating part for generating a prospective customer list of the prospective customers for each shop;
a prospective customer notifying part provided with a prospective customer list presenting part for presenting the prospective customer list to the shop;
an advertisement distribution selecting part of allowing the shop to determine whether or not the advertisement is to be distributed to the prospective customers in the prospective customer list;
a name-embedded advertisement generating part for generating name-embedded advertisement including shop identity information capable of identifying the shop; and
a name-embedded advertisement distributing part for distributing the name-embedded advertisement to the prospective customers who have been selected to receive the name-embedded advertisement by the advertisement distribution selecting part.

15. An advertisement distributing system according to claim 14, wherein information representing a distribution starting time of the advertisement is prescribed to be an advertisement distribution starting requirement, and
the system includes an advertisement distribution time control part for allowing the advertisement distribution selecting part to continue accepting selection of prospective customers until the time represented by the advertisement distribution starting requirement, and starts processing of the name-embedded advertisement generating part and the name-embedded advertisement distributing part at the advertisement distribution time.

16. An advertisement distributing server, comprising:
a prospective customer searching part for searching for prospective customers of an advertising article from an accessible customer database;
a shop database storing shop information;
a shop searching part for searching for shops capable of selling the article to the prospective customers from the shop database;
a prospective customer list generating part for generating a prospective customer list of prospective customers for each shop;
a prospective customer list sending part for sending the prospective customer list for each shop to the shop;
a name-embedded advertisement generating part for receiving a result of the shop's determination whether or not the advertisement is to be distributed to the prospective customers in the prospective customer list, and generating name-embedded advertisement including shop identity information capable of identifying the shop, based on the result;
a name-embedded advertisement distributing part for distributing the name-embedded advertisement to the prospective customers who have selected to receive the name-embedded advertisement by the advertisement distribution selecting part.

17. An advertisement distributing client, comprising:
a prospective customer notifying part for receiving a prospective customer list that is a search result of prospective customers of an advertising article from a customer database accessible from an advertisement distribution server, and presenting the list to a shop side;
an advertisement distribution selecting part for determining whether or not advertisement of the article is to be distributed to the prospective customers in the prospective customer list; and
an advertisement distribution selection result notifying part for returning a selection result of the advertisement distribution selecting part to the advertisement distributing server,
the advertisement distributing client requesting the advertisement distributing server to distribute the advertisement to customers who are specified to receive the advertisement.

18. A computer-readable recording medium storing a processing program for implementing an advertisement distributing system for distributing advertisement of an advertising article to prospective customers assumed to purchase the article, the processing program comprising:
a prospective customer searching operation of searching for prospective customers of an advertising article from customer information;
a shop searching operation for searching for shops capable of selling the article to the prospective customers from shop information;
a prospective customer notifying operation of creating a prospective customer list of customers to which the shop is capable of selling the article, for each shop, and notifying the shop of the list;
an advertisement distribution selecting operation of allowing the shop to determine whether or not the advertisement of the article to the prospective customers in the notified prospective customer list;
a name-embedded advertisement generating operation of generating name-embedded advertisement in which shop identity information capable of identifying the shop is added to the advertisement previously registered; and
a name-embedded advertisement distributing operation of distributing the name-embedded advertisement to prospective customers selected to receive the name-embedded advertisement in the advertisement distribution selecting operation.
